(19) United States
(12) Patent Application Publication
(10) Pub. No.: US 2020/0202369 A1
(43) Pub. Date: Jun. 25, 2020

(54) DIGITAL SURVEYS BASED ON DIGITALLY DETECTED FACIAL EMOTIONS

(71) Applicant: Qualtrics, LLC, Provo, UT (US)

(72) Inventor: Rahul Datta, Seattle, WA (US)

(21) Appl. No.: 16/226,219

(22) Filed: Dec. 19, 2018

(51) Int. Cl. G06Q 30/02; G06K 9/00

(52) U.S. Cl. CPC G06Q 30/0203; G06K 9/00288; G06K 9/00302

(57) ABSTRACT

This disclosure covers methods, systems, and computer-readable media that generate a digital survey for respondents based on emotion attributes determined for the respondents from analyzed images of the respondents. In certain embodiments, by generating digital surveys by analyzing images for emotion attributes, the disclosed systems generate digital surveys that are customized for a respondent. To facilitate review of respondents' emotion attributes and the reliability of responses, in some embodiments, the disclosed systems further associate the emotion attributes with responses within a response database for the digital survey.

### BACKGROUND

Various institutions in a wide range of disciplines (e.g., business, government, and education) rely on digital surveys to gather critical information from survey audiences (e.g., customers, employees, citizens, and students) regarding a wide range of issues and topics. However, as digital content continues to proliferate, audiences find both a seemingly endless amount of digital content competing for their attention and numerous computing devices that display that digital content. This increase in both digital content and computing devices complicates the administration of digital surveys, and accordingly, digital surveys present a unique challenge to survey administrators because survey respondents are bombarded with digital content and, often times, do not respond to digital surveys.

To attempt to overcome poor digital survey completion rates, conventional systems often provide digital surveys to massive respondent populations in an effort to collect a significant amount of feedback. However, the mass distribution of a digital survey creates several drawbacks. For instance, due to the nature of mass surveys, when a potential survey respondent receives a digital survey on a mobile device or computer, the digital survey is often times irrelevant or insignificant to a potential survey respondent. Thus, providing digital surveys to disinterested survey respondents often prevents conventional systems from receiving a response from the potential survey respondents. Furthermore, even when a disinterested survey respondent does choose to complete a digital survey, the disinterested survey respondent may provide unreliable information since the digital survey is about a subject that is insignificant to the respondent. Accordingly, conventional digital survey systems often have low response rates and/or collect unreliable information from disinterested digital survey respondents.

As a result of low response rates and the potential of collecting unreliable information, conventional systems often utilize excessive computational resources to administer digital surveys to massive populations without achieving an adequate and/or accurate response data set. This often results in an inefficient and high-volume utilization of communication bandwidth because a large volume of digital survey data is sent by conventional digital survey systems with little to no gain (e.g., no response and/or unreliable responses). Furthermore, providing digital surveys to any or all available respondents oftentimes lead conventional digital survey systems to have an increased amount of storage and database complexity because the conventional systems may maintain data on respondents that are unresponsive or maintain large amounts of unreliable data. Moreover, as survey response databases become larger and larger, the amount of response data to process to provide digital survey results becomes larger, which in turn demands more processing resources, leads to longer report generation times, and decreases the efficiency of conventional systems.

In addition to computational and communication inefficiencies, conventional survey systems often cannot determine whether a respondent responded genuinely and accurately to an administered digital survey. In other words, most conventional systems cannot determine the difference between reliable respondent-provided responses and unreliable respondent-provided responses. For example, conventional systems often cannot detect whether the respondent had a particular experience that the survey is addressing, how recently the respondent had that experience, and/or if the respondent is meaningfully participating in the survey. Thus, conventional systems often default to treating all response data as reliable, which can inadvertently produce inaccuracies in digital survey results.

Accordingly, conventional digital survey systems suffer from these and other disadvantages.

### SUMMARY

This disclosure describes solutions to some or all the foregoing problems with systems, methods, and non-transitory computer-readable media that administer a digital survey to respondents of the digital survey. For instance, the disclosed systems administer a digital survey to a respondent based on digitally detecting a respondent's emotion from a digital image of the respondent. Moreover, the disclosed systems and methods determine an emotion attribute of a respondent based on a digital image of the respondent and generate content (e.g., a digital survey question) of a digital survey based on the emotion attribute. The disclosed systems and methods then provide the customized content within a digital survey to a client device associated with the respondent. By determining the emotion attribute of a respondent and generating content of the digital survey based on the emotion attribute, the disclosed systems and methods identify respondents that are more likely to respond to a digital survey and also provide a customized digital survey that is more relevant to those respondents.

The following description sets forth additional features and advantages of one or more embodiments of the disclosed systems and methods. In some cases, such features and advantages will be obvious to a skilled artisan from the description or may be learned by the practice of the disclosed embodiments.

### BRIEF DESCRIPTION OF THE DRAWINGS

The detailed description is described with reference to the accompanying drawings in which:

FIG. 1 illustrates a block diagram of an environment for implementing an emotion based digital survey system in accordance with one or more embodiments.

FIG. 2 illustrate a sequence-flow diagram of analyzing an image to determine emotion attributes and generate content for a digital survey based on the emotion attributes in accordance with one or more embodiments.

FIG. 3A illustrates a capture system providing images to an emotion based digital survey system in accordance with one or more embodiments.

FIG. 3B illustrates an emotion based digital survey system analyzing an image to determine emotion attributes and generating content for a digital survey based on the emotion attributes in accordance with one or more embodiments.

FIG. 3C illustrates a respondent database in accordance with one or more embodiments.

FIG. 3D illustrates digital survey content within a digital survey database in accordance with one or more embodiments.

FIG. 4 illustrates an example environment in which an emotion based digital survey system can operate in accordance with one or more embodiments.

FIG. 5 illustrates a flow diagram of analyzing an image to determine a respondent identifier in accordance with one or more embodiments.

FIG. 6 illustrates an emotion based digital report in accordance with one or more embodiments.

FIG. 7 illustrates a response database in accordance with one or more embodiments.

FIG. 8 illustrates a flowchart of a series of acts for identifying a respondent identifier and determining emotion attributes from an image to generate content for a digital survey in accordance with one or more embodiments.

FIG. 9 illustrates a block diagram of a computing device in accordance with one or more embodiments.

FIG. 10 illustrates a network environment of an emotion based digital survey system in accordance with one or more embodiments.

### DETAILED DESCRIPTION

This disclosure describes one or more embodiments of an emotion based digital survey system that determines emotion attributes of respondents and generates a digital survey based on the emotion attributes of those respondents. For instance, the emotion based digital survey system administers a digital survey to a respondent based on digitally detecting the respondent's emotion from a digital image of the respondent. In some embodiments, for example, the emotion based digital survey system determines an emotion attribute of a respondent based on a digital image of the respondent and generates content (e.g., a digital survey question) of a digital survey based on the emotion attribute. The emotion based digital survey system then provides the customized content within a digital survey to a client device associated with the respondent. By determining the emotion attribute of a respondent and generating content of the digital survey based on the emotion attribute, the disclosed systems and methods identify respondents that are more likely to respond to a digital survey and also provide a customized digital survey that is more relevant to those respondents. Moreover, to facilitate review of responses of respondents based on emotion attributes of the respondent, the emotion based digital survey system categorizes the determined emotion attributes within a response database for use in reporting and reviewing survey results.

For instance, in some embodiments, the emotion based digital survey system (or simply “digital survey system”) receives images and identifies respondents based on the received images. In some instances, the digital survey system receives images of potential respondents from various capture devices (e.g., retail store cameras or a company security camera). Then, for example, the digital survey system identifies a respondent depicted within an image by analyzing the image in collaboration with other image databases (e.g., a retailer's membership ID card database or a company's employee directory database). Once the respondent is identified, the digital survey system can access a respondent identifier that is associated with a method of sending a digital survey to the identified respondent (e.g., a phone number or email).

In addition to identifying a respondent depicted within an image, the digital survey system can analyze the image to determine the emotion portrayed by the respondent in the image. In one or more embodiments, the emotion based digital survey system may utilize a third-party software to analyze the image to determine an emotion attribute. Moreover, the emotion based digital survey system can determine an emotion attribute from an image and store the emotion attribute in the form of an identifier or a machine-readable value on a database of the digital survey system.

Furthermore, in one or more embodiments, the digital survey system utilizes the respondent identifier and the determined emotion attribute corresponding to the identified respondent in the image to generate customized content for a digital survey. For instance, in some embodiments, the digital survey system determines questions for the digital survey based on the emotion attribute corresponding to a respondent identifier. The questions for the digital survey can be selected from a database, containing question elements associated with emotion attributes and other attributes. Accordingly, the digital survey system can select a question customized for a respondent that is identified as angry in the event the emotion attribute indicates the respondent is angry, or on the other hand, the digital survey system can select a question customized for a respondent that is happy in the event the emotion attribute indicates the respondent is happy. Additionally, in one or more embodiments, the digital survey system can utilize the emotion attribute to determine a survey question format for the digital survey content.

In addition to determining survey question content and format based on an emotion attribute, in some embodiments, the digital survey system can utilize the emotion attribute to determine a transmission format for the digital survey content. For example, based on the emotion attribute indicating the respondent is happy, the digital survey system can determine that the digital survey content will be transmitted through e-mail (e.g., based on the digital survey system determining that it is not crucial to get in contact with the respondent immediately). In contrast, based on the digital survey system determining that the emotion attribute indicates that the respondent is very angry, the digital survey system can determine to immediately have a customer representative call the respondent (e.g., based on the digital survey system determining it is important to get in contact because the respondent likely needs help).

Upon generating content for the digital survey and determining a survey transmission format based on the emotion attribute, the digital survey system can also provide the digital survey to the respondent associated with the respondent identifier. For example, the emotion based digital survey system can provide a customized digital survey to a respondent by transmitting the digital survey to the respondent through an e-mail address associated with the respondent identifier. In one or more embodiments, the emotion based digital survey system can provide the generated digital survey to more than one respondent. For example, the emotion based digital survey system can identify more than one respondent identifiers from a received image and determine whether a generated digital survey should be sent to each of the respondents represented by the respondent identifiers.

In addition to generating a customized digital survey for a respondent identified in an image, the digital survey system can utilize images captured from a capture device to automatically generate responses to survey questions based on the emotion attributes identified in an image. For example, in some embodiments, the digital survey system can analyze one or more multiple images from a location to determine an emotion attribute for each image. Further, the digital survey system can utilize the determined emotion attributes for each image to identify survey responses for the location (e.g., customer satisfaction in a café). In one or more embodiments, the emotion based digital survey system does not identify respondent identifiers when determining emotion attributes from images, but instead analyzes the images to determine emotion attributes of people depicted within the images to generate survey response data, as will be explained in further detail below.

Additionally, the digital survey system can utilize the determined emotion attributes for respondents and digital survey responses to generate reports for further analysis. In particular, the digital survey system can generate a report to determine how the emotion attribute of a respondent corresponds to the responses of the respondent on a digital survey. For example, the digital survey system can generate a report to determine how the emotion attribute determined from an image (e.g., taken when the respondent visited a retail store) corresponds to the response of a respondent to a digital survey question (e.g., how often the respondent visits the retail store). Moreover, the digital survey system can utilize the emotion attribute in association with digital survey responses to determine a reliability score of a response (e.g., if a respondent was in fact happy when visiting a retail store when the response of the respondent to a digital survey indicates that the respondent was happy).

By determining an emotion attribute for a respondent and generating content for a digital survey based on the emotion attribute, the digital survey system achieves a higher response rate in comparison to some conventional systems. Specifically, the digital survey system can generate digital surveys that are more relevant to a respondent's actual experience, thus resulting in a higher response rate. Accordingly, the digital survey system utilizes less computational resources because the disclosed system needs to generate and transmit fewer digital surveys to obtain responses from respondents in comparison to conventional systems. Furthermore, the digital survey system also requires less data collection on respondents that are not likely to respond to digital surveys, which leads to less clutter in data management of the digital survey system.

In addition to better response rates to digital surveys, the digital survey system also provides generated digital surveys to respondents that are not disinterested in receiving the generated surveys (whereas conventional digital survey systems often provide surveys to disinterested respondents). Specifically, the digital survey system reduces the likelihood of the generated surveys from being classified as spam or junk by computing systems of the respondent in comparison to some conventional digital survey systems. As a result, the digital survey system can avoid more computer-based spam filtration systems in comparison to conventional digital survey systems. Accordingly, this allows the digital survey system to operate with less computational resources (i.e., less storage space required due to a lesser need to maintain a list of respondents that are unresponsive) and less bandwidth traffic because the digital survey system does not need to send mass digital surveys to collect relevant and quality data.

Moreover, by associating digital survey responses to the emotion attribute of a respondent, the digital survey can more accurately determine whether a digital survey response was genuine in comparison to most conventional digital survey systems. Specifically, the disclosed emotion based digital survey system can detect whether a digital survey response is in line with the associated emotion attribute of the respondent. Accordingly, the disclosed emotion based digital survey system can obtain a more accurate understanding from responses to digital surveys in comparison to conventional systems, which produce more accurate responses and more accurate survey results.

This disclosure discusses the digital survey system using multiple terms. A definition of various terms used throughout this disclosure are provided for ease of reference. As used in this disclosure, the term “digital survey” refers to a digital communication that collects information concerning one or more respondents by capturing information from (or posing questions to) such respondents. For example, “digital survey” can refer to a set of digital survey questions or content intended for distribution over a network (e.g., network 112) by way of client devices and further intended to collect responses to the digital survey questions for generating survey results from the collected responses. A digital survey can include one or more digital survey questions and corresponding answer choices that accompany the given question. Accordingly, a digital survey may include digital survey content (e.g., one or more digital survey questions). Alternately, a digital survey may capture responses without digital survey questions, such as by capturing images of respondents through a capture system, and based on analyzing the images, generate survey response data directly without specifically sending a digital survey to a respondent.

Moreover, the term “digital survey content” (or “content”) refers to elements included in a digital survey. In particular, content includes elements that form a digital survey such as, but not limited to, digital survey questions, survey question formats, transmission formats, or information about a respondent. For example, content includes digital survey questions, e.g., prompts that invoke a response from a respondent, or that requests information from a respondent. Moreover, content includes, both, information that is visible to a respondent in the digital survey and background data.

Additionally, as used herein, the term “digital survey question” (or “survey question”) refers to a prompt included in a digital survey that invokes a response from a respondent, or that requests information from a respondent. In one or more embodiments, when one or more answer choices are available for a digital survey question, a digital survey question may include a question portion as well as an available answer choice portion that corresponds to the survey question.

As used in this disclosure, the term “respondent” refers to any person that is the subject of a survey. In particular, the term “respondent” refers to a person that participates in a digital survey. For example, a respondent includes a person that receives a digital survey and can provide a response to the digital survey. For example, a respondent can include a person that shops at a retail store and receives a digital survey from the retail store. Moreover, a respondent can include a person whose image is captured while at the retail store, and based on image analysis to determine an emotion attribute of the person, the person participates in a digital survey without explicitly providing a response to a survey question.

Moreover, the term “image” refers to a visual representation of an object or a person. For example, an image can include a visual representation of a person captured by a camera (e.g., a digital camera). Example types of images include, but are not limited to, digital files such as a JPEG, PNG, TIFF or a BMP file. Furthermore, an image can also include a video captured by a capture device. For instance, an image can include a video file captured from a video camera (e.g., an AVI, FLV, MOV, WMV, or an MP4 file). An image can include a visual representation of a respondent in either a digital image file or a video file.

As used in this disclosure, the term “respondent identifier” refers to an informational representation of a respondent. The term “respondent identifier” can refer to a label or a tag to represent a respondent and any other information for a respondent. For example, the respondent identifier can include, but is not limited to, a numerical value and/or a textual value that refers to a respondent and all of the respondent's information. In some embodiments, the respondent identifier can be an ID number (an integer) in a database (i.e., ID number 1245 for respondent Billy Roberts). Furthermore, the respondent identifier (the ID number) can link to other database tables to retrieve other information for the respondent (i.e., the contact information of a respondent).

Moreover, the term “emotion attribute” refers to an informational representation of various types of emotions. In particular, the term “emotion attribute” refers to a label or a tag for various human based emotions. Specifically, an emotion attribute can be a set of identifiers (e.g., integers, flags, or text) that are mapped to human emotions (e.g., happiness, anger, sadness, fear, surprise, or disgust). For example, happiness can be an emotion attribute that is represented as the integer 1 in the emotion based digital survey system. Furthermore, in some embodiments, an emotion attribute can be associated with an emotion attribute scale. As used in this disclosure, the term “emotion attribute scale” refers to a mechanism to weigh emotion attributes. Particularly, an “emotion attribute scale” refers to a mechanism that scores the prominence of an emotion attribute by associating the emotion attribute with a weight. For instance, the emotion attribute scale can be represented as a numerical weight that scores the prominence of an emotion attribute. More specifically, for example, the emotion attribute scale can score an emotion attribute associated with a respondent (i.e., happiness) from 1-10, whereas happiness with a weight of 1 signifies a minimal amount of happiness and a weight of 10 signifies an extreme amount of happiness.

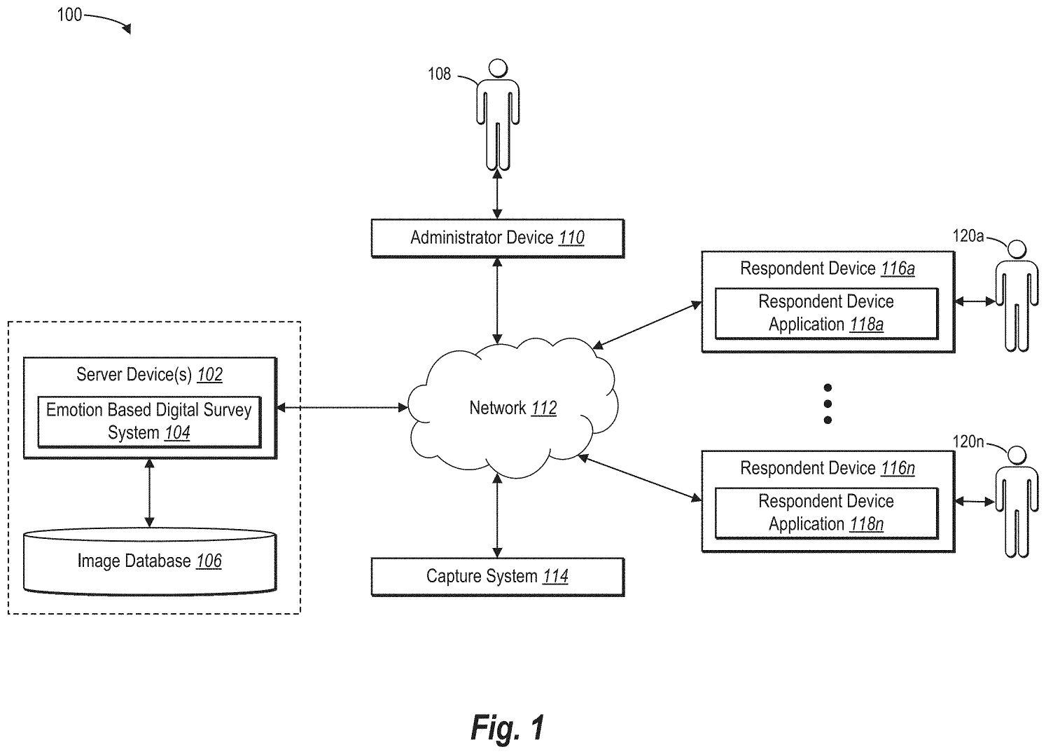

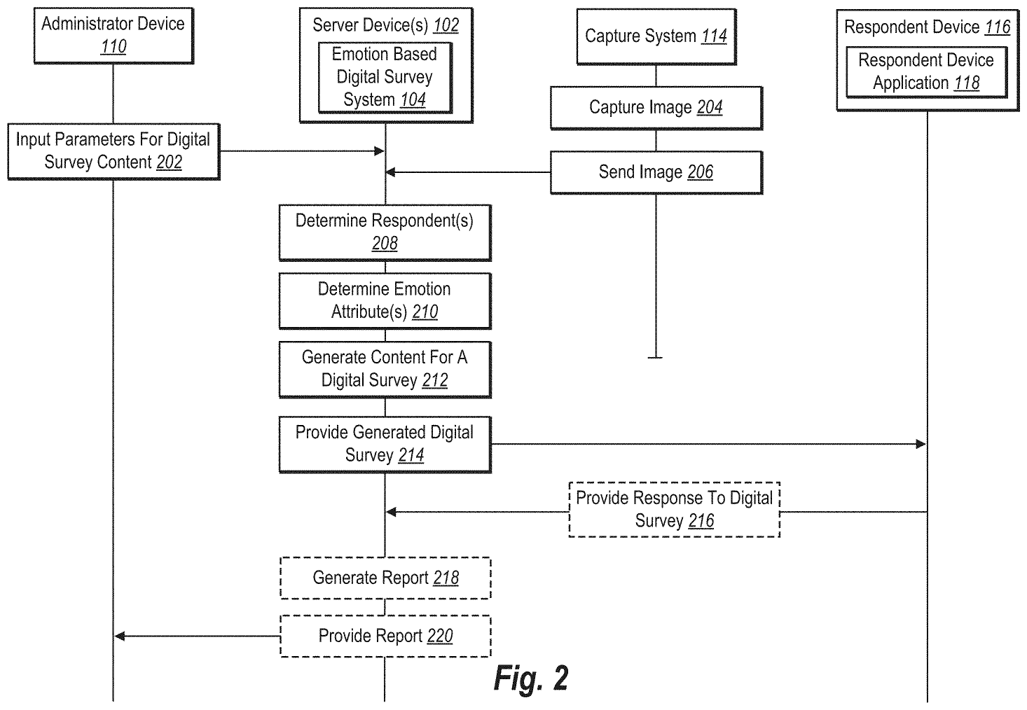

Turning now to the figures, FIG. 1 provides an overview of an environment 100 in which an emotion based digital survey system 104 (or simply “digital survey system 104”) can operate. After providing an overview of the environment 100, this disclosure describes embodiments of the digital survey system 104 in more detail with reference to FIGS. 2-8.

As illustrated in FIG. 1, the environment 100 includes an administrator device 110 associated with a survey administrator 108. The environment 100 further includes respondent devices 116a through 116n (collectively referred to as “respondent devices 116”) that are respectively associated with survey respondents 120a through 120n (collectively referred to as “survey respondents 120”). Each of the respondent devices 116a through 116n also respectively comprise a respondent device application 118a through 118n (collectively referred to as the “respondent device applications 118”). The survey respondents 120 may interact with the respondent device applications 118 to respond to digital survey questions. In some embodiments, the respondent device applications 118 comprise web browsers, applets, dedicated applications (e.g., dedicated digital survey applications), instant message applications, SMS applications, email applications, and/or other software applications available to the respondent devices 116.

As further shown in FIG. 1, the environment 100 also includes a capture system 114. The capture system 114 can capture digital images (e.g., still or video images) of respondents 120. In some embodiments, the capture system 114 includes one or more capture devices that enable the capture system 114 to capture images of respondents 120. Moreover, the capture system 114 may, in one or more embodiments, provide images to the network 112, to the server device(s) 102, the respondent devices 116, the administrator device 110, and/or to the image database 106. The capture system 114 can be provided by any entity, such as, but not limited to, the survey administrator 108, a third-party capture device, a third-party business, and/or a respondent device. As used in this disclosure, the term “capture device” refers to a device that can capture a visual representation of a person or an object. In particular, a capture device can capture, record, store, or save an image. In some examples, a capture device can include, but is not limited to, a digital camera, an IP camera, a phone camera, or a video camera. For example, the capture device can include a camera in a retail store or a restaurant.

The environment 100 also includes an image database 106. The image database 106 can store images. In some embodiments, the image database 106 includes images provided by the server device(s), the capture system 114, the network 112, the respondent devices 116, and the administrator device 110. Furthermore, the image database 106 can also include images provided from other sources such as, but not limited to, third-party servers, third-party databases, third-party storage systems, third-party applications, and third-party websites. Moreover, the image database 106 can be within the server device(s) 102 and/or part of a separate system.

In general, the image database 106, the administrator device 110, the respondent devices 116, and the capture system 114 communicate with server device(s) 102, including the digital survey system 104, over a network 112. As described below, the server device(s) 102 enable various functions, features, processes, methods, and systems described herein using, for example, the digital survey system 104. Additionally, or alternatively, the server device(s) 102 coordinate with the administrator device 110, the respondent devices 116, and/or the capture system 114 to perform or provide the various functions, features, processes, methods, and systems described in more detail below. Although FIG. 1 illustrates a particular arrangement of the server device(s) 102, the image database 106, the administrator device 110, the respondent devices 116, the capture system 114, and the network 112, additional arrangements are possible. For example, the server device(s) 102 and the digital survey system 104 may directly communicate with the administrator device 110 and thus bypass the network 112.

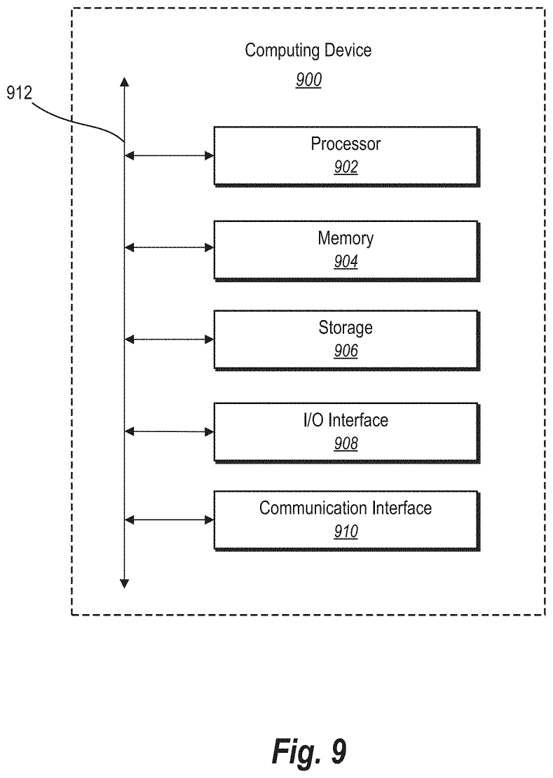

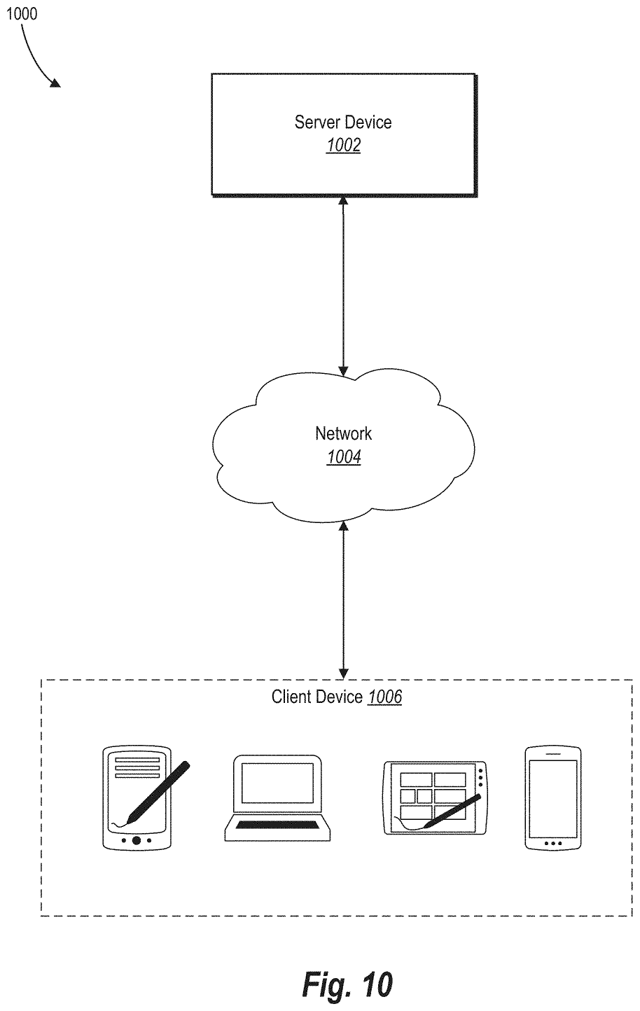

The administrator device 110 and the respondent devices 116 can include any one of various types of client devices. For example, the administrator device 110 and the respondent devices 116 can be mobile devices, tablets, laptop computers, desktop computers, smart televisions, televisions, monitors, smart home devices, digital kiosks, or any other type of computing device, as further explained below with reference to FIG. 9. Additionally, the server device(s) 102 can include one or more computing devices, including those explained below with reference to FIG. 9. The administrator device 110, the respondent devices 116, the capture system 114, server device(s) 102, and network 112 may communicate using any communication platforms and technologies suitable for transporting data and/or communication signals, including any known communication technologies, devices, media, and protocols supportive of data communications, examples of which are described with reference to FIG. 10.

In certain embodiments, the digital survey system 104 provides tools to the administrator device 110 for the survey administrator 108 to compose digital survey content and other digital survey communication settings for the digital survey system 104. In one or more embodiments, accessing the digital survey system 104, the server device(s) 102 provide one or more digital documents (e.g., webpages) to the administrator device 110 to allow the survey administrator 108 to compose the content of digital surveys. The digital documents include tools and options that facilitate composing a digital survey for distribution to the respondent devices 116, composing digital survey content for the digital survey system 104 to utilize when generating digital surveys, and/or composing preferences for digital survey communication settings (e.g., preferences for how a digital survey should be, during the generating step, conducted, formatted, distributed, etc.).

Furthermore, the digital survey system 104 can obtain images from a capture system 114 or an image database 106. The digital survey system 104 analyzes the obtained image of person to determine a respondent 120 (i.e., by identifying a respondent identifier in the server device(s) 102) and an emotion attribute associated with the respondent. The digital survey system 104 can utilize the image, the identity of a respondent 120, and the emotion attribute from the image to generate or select custom content for a digital survey (i.e., utilizing the composed content and communication settings provided by the survey administrator 108).

After the digital survey system 104 generates content for a digital survey utilizing the image provided by the capture system 114 or the image database 106, the information provided by the survey administrator 108 through an administrator device 110, the determined respondent identifier, and the determined emotion attribute, the digital survey system 104 provides the digital survey (in compliance to the generated content and communication settings) to one or more respondent devices 116 through the network 112. Additionally, the digital survey system 104 can also store the generated digital survey in the server device(s) 102 or provide the generated digital survey to an administrator device 110 or another third-party device.

Moreover, upon receiving the digital survey from the digital survey system 104 on the one or more respondent devices 116, the respondents 120 can provide a response to the digital survey. The response is provided to the server devices(s) over the network 112 by the respondent devices 116. Additionally, the digital survey system 104 can store the digital survey response from the respondent devices 116 as a digital survey result on the server device(s) 102. In one or more embodiments, the digital survey system 104 can utilize the survey results to generate digital survey reports on the server device(s) or the administrator device 110. Moreover, in one or more embodiments the digital survey system 104 can generate other types of digital reports (i.e., an emotion based digital report) utilizing information (i.e., images) provided by the capture system 114, the respondent devices 116, or the administrator device 110. The digital survey system 104 can provide these digital reports to other devices such as, but is not limited to, the administrator device 110, other third-party devices, and the network 112.

Turning now to FIG. 2, these figures provide an overview of embodiments of the digital survey system 104 that determine emotion attributes from images, generate and/or select content for digital surveys based on those emotion attributes, and administer the generated digital survey to a corresponding respondent. Specifically, FIG. 2 illustrates a representation of a sequence of acts 202-220 that the administrator device 110, the server device(s) 102, the capture system 114, and/or the respondent devices 116 (via respondent device applications 118) perform to, among other things, customize content for digital surveys based on emotion attributes of respondent from an image. For instance, in some embodiments, the administrator device 110, the server device(s) 102, the capture system 114, or the respondent devices 116 include computer-executable instructions that, when executed by a processor thereon, cause the administrator device 110, the server device(s) 102, the capture system 114, or the respondent devices 116 to perform one or more of the acts 202-220 shown in FIG. 2.

For ease of reference, the following paragraphs describe the digital survey system 104 as performing one or more of the acts 202-220 rather than the server device(s) 102. As suggested above, the digital survey system 104 comprises computer-executable instructions that cause the server device(s) 102 to perform one or more of the acts 202-220. Rather than repeatedly describe the relationship between the instructions within the digital survey system 104, on the one hand, and the server device(s) 102, on the other hand, this disclosure will describe the digital survey system 104 as performing the acts as a shorthand for that relationship. Additionally, while the paragraphs below often describe the acts 202-220 in relation to a single digital survey question and a single response to the digital survey question, certain embodiments of the acts 202-220 involve multiple digital survey questions and multiple digital survey responses to the digital survey questions.

Turning back now to the acts of 202-220, as noted above, the administrator device 110 performs act 202 of receiving and sending input parameters for digital survey content to the server device(s) 102. As noted above, the digital survey system 104 provides tools to the administrator device 110 for the survey administrator 108 to compose one or more digital survey questions or communication settings (i.e., digital survey content). To facilitate the composition of such digital survey content, the digital survey system 104 provides tools, selectable options, and/or menus within a graphical interface to compose a textual and/or other query.

For example, in some embodiments, the digital survey system 104 provides a digital survey template to the administrator device 110 for presentation within a graphical user interface. In such embodiments, the digital survey template comprises a digital space in which the survey administrator 108 may compose, format, edit, and/or otherwise create digital survey content. In particular, in some embodiments, the digital survey system 104 provides digital survey templates (or “electronic survey templates”) as described in application Ser. No. 15/339,169, filed Oct. 31, 2016, entitled Guiding Creation of an Electronic Survey, which is hereby incorporated by reference in its entirety.

To facilitate the digital survey system 104 to generate a digital survey based on emotion attributes, in some embodiments, the digital survey system 104 provides to the administrator device 110 selectable options (for presentation within the graphical user interface) to associate emotion attributes to digital survey content. Regardless of how the selectable option is presented, the digital survey system 104 provides selectable options to associate emotion attributes to digital survey content comprising an ID system or tagging system to represent associated emotion attributes for certain digital survey content. For example, in one or more embodiments, the survey administrator 108 can select an emotion attribute for joy (i.e., an ID tag corresponding to joy in the digital survey system 104) for particular digital survey questions (i.e., “What did you enjoy most about your visit?”). Moreover, the survey administrator 108 can also select emotion attributes to associate with particular survey distribution channels (i.e., associate the emotion attribute equivalent of “joy” to sending digital surveys by E-mail and free form text survey question format). The survey administrator 108 can associate emotion attributes with digital survey content in any number of combinations and is not limited to a one to one relationship (i.e., the associations with digital survey content can include a combination of emotion attributes and other factors).

As further shown in FIG. 2, in addition to receiving parameters for digital survey content from the administrator device 110, the digital survey system 104 also receives images in act 206 that are captured in act 204 from a capture system 114. In some embodiments, the capture system 114 captures images in act 204 (i.e., image files or video files) from a capture device. For example, the capture system 114 can include a security camera system within a retail store, a restaurant, or a university. Furthermore, the capture system 114 can also include traffic cameras, employee ID verification cameras, or specially placed survey image capture devices used specifically with the digital survey system 104.

The capture system 114, can capture images in act 204 and store the images on a storage unit that exists on the capture system 114. Moreover, the capture system 114 can also capture images in act 204 and store them on a remote storage device or server by using the network 112 (i.e., an IP camera). Alternatively, in one or more embodiments, the capture system 114 can be in possession of images without performing the act of capturing images 204 (i.e., utilizing stored images on the capture system or utilizing images obtained from another source such as a third-party server). Furthermore, in one or more embodiments, the capture system 114 can be a capture device on a respondent device 116.

As briefly noted above, the capture system 114 sends one or more images in act 206 to the server device(s) 102 (i.e., to the digital survey system 104). The capture system 114 can send images in act 206 that are captured in act 204 by the capture system 114 to the server device(s) 102 via the network 112. In some embodiments, the capture system 114 can send the images in act 206 to the administrator device 110, the server device(s) 102, or the image database 106 either directly or via the network 112. Moreover, the capture system 114 can send the images in act 206 to the server device(s) in real-time or by sending images that are stored on the capture system 114. In one or more embodiments, the capture system 114 can be a database of images that is accessed directly by the server device(s) 102 (i.e., an image database 106).

Upon receiving the images from act 206 from the capture system 114, FIG. 2 further illustrates that the digital survey system 104 performs act 208 to determine a respondent based on the image sent from act 206 by the capture system 114. The digital survey system 104 can analyze the sent image from act 206 (or any image that is available in the server device(s) 102) by comparing the received image from act 206 with other images that include identified respondents (e.g., “a labeled image”) to determine the respondent in the received image from act 206. Moreover, as part of the act of determining a respondent 208 from the image, the digital survey system 104 identifies a corresponding respondent identifier within the system for the sent image from act 206. The digital survey system 104 then, in one or more embodiments, stores the respondent identifier with a reference to the image in the server device(s) 102. Alternatively, in one or more embodiments, the digital survey system 104 creates a new respondent identifier corresponding to the determined respondent in the image if a respondent identifier for the respondent does not exist.

In one or more embodiments, the digital survey system 104 can utilize image databases with known respondent identities when determining a respondent in act 208 from a sent image from act 206. For instance, the digital survey system 104 can access a database within the server device(s) 102 containing information on respondents such as the name of the respondent, the contact information of a respondent, and an image of the respondent (i.e., the labeled image). Additionally, this information can be used by the digital survey system 104 to compare the sent image from act 206 from the capture system 114 to the respondents in the database within the server device(s) 102 and the corresponding labeled images for those respondents to determine the respondent in act 208 in the sent image from act 206. In alternate embodiments, the digital survey system 104 can access third party databases to obtain labeled images for comparison with sent images from act 206 when the digital survey system 104 determines respondents in act 208. For example, the digital survey system 104, in one or more embodiments, can use a state driver's license agency data base to obtain an image with corresponding information (i.e., the name of the person within the image). Additionally, the labeled images can also be obtained from other sources such as, but not limited to, a database for store membership cards, passport pictures, social network accounts, and school ID databases. The digital survey system 104 can utilize such labeled image data from third-party providers or from the server device(s) 102 to determine the identity of a respondent in act 208 from a sent image from act 206.

Furthermore, to determine a respondent in act 208 from the sent image from act 206, the digital survey system 104 can also apply face recognition algorithms to the image. By applying face recognition algorithms, the digital survey system 104, measures certain features of the face and head of the person (i.e., a survey respondent 120a) captured within the image. In certain instances, the digital survey system 104 applies facial recognition algorithms to detect and measure the distance among facial features shown in an image (or multiple images from a video), including, for example, a hairline, forehead, left eyebrow, right eyebrow, glabella, left eye, right eye, nose bridge, nose tip, left nostril, right nostril, scar, mole, freckle, pimple, left ear, right ear, lip curve, tubercle of an upper lip, top portion of a lip, bottom portion of a lip, mouth corner, or chin. Additionally, in some embodiments, the digital survey system 104 applies facial recognition algorithms to detect and measure colors of facial or head features, including, for example, eye color, hair color, or skin tone, and/or to detect and measure the presence and dimensions of certain facial features, including, for example, facial hair, cranial hair, or laryngeal prominences (a.k.a. Adam's apples). Moreover, in some embodiments, the digital survey system 104 applies facial recognition algorithms to detect and measure accessories, including, for example, ear rings, glasses, hats, headdress, jewelry, lip rings, make-up, nose rings, or scarves. Accordingly, the digital survey system 104 can utilize the facial recognition algorithms to compare the sent image 206 with the labeled images in order to determine a respondent in act 208.

When applying a facial recognition algorithm as part of act 208, in some cases, the digital survey system 104 applies well-known techniques or more recently developed facial recognition algorithms. For example, the digital survey system 104 optionally applies Elastic Bunch Graph Matching, a hidden Markov model, an Eigenface algorithm, a Face++ algorithm, Fisherface algorithm, a GaussianFace algorithm, a Human Perception Based Fusion Scheme (“HPFS”), multilinear subspace learning, or neuronal motivated dynamic link matching. GaussianFace is described by Chaochao Lu and Xiaoou Tang, “Surpassing Human-Level Face Verification Performance on LFW with GaussianFace,” Proceedings of the 29th AAAI Conference on Artificial Intelligence (AAAI-15) (2014), which is incorporated in its entirety by reference. HPFS is described by Daksha Yadav, Richa Singh, Mayank Vatsa, and Afzel Noore, “Recognizing Age-Separated Face Images: Humans and Machines,” PLOS ONE (December 2014), which is likewise incorporated in its entirety by reference. In some embodiments, digital survey system 104 uses a facial Application Program Interface (“API”), such as Microsoft Corporation's Face API, to apply a facial recognition algorithm to determine a respondent 208 from the sent image 206 from the capture system 114.

In some embodiments, the digital survey system 104 can utilize machine learning models to determine an identity of respondent(s) 208 associated with a sent image from act 206. As used in this disclosure, the term “machine learning model” refers to an algorithm that can learn from labeled training data and make predictions from unlabeled input data. In particular a machine learning model can include a neural network that can be, or is trained, to accurately analyze images. Specifically, a machine learning model can include a neural network that can be, or is trained, to analyze images to accurately determine either an identity of a person (i.e., a respondent identifier) and/or emotion attributes of a person. For example, the neural network may operate by building models from example inputs (e.g., training or learning), such as a training dataset, to make data-driven predictions or determinations.

For example, in one or more embodiments, the digital survey system 104 can utilize training images of persons with corresponding identification information for the persons (i.e., ground truth training data) to determine respondents in act 208 from the sent images from act 206. Specifically, in some embodiments, the digital survey system 104 provides training images of persons with corresponding ground truth training data to a neural network. The digital survey system 104 causes the neural network to analyze the training images and predict an identity for the person portrayed in the training image (i.e., a respondent identifier). Subsequently, the digital survey system 104 compares the predicted identity information from the training images with the ground truth training data to determine the accuracy of the predicted identity information. Based on the accuracy, the digital survey system 104 either optimizes the neural network and repeats the training process of the neural network or begins utilizing the trained neural network to determine respondents in act 208 from the unlabeled images sent by the capture system 114.

In one or more embodiments, the machine learning model can comprise of a convolutional neural network (CNN), a recurrent neural network (RNN), or any other deep learning models. Furthermore, in some embodiments, the digital survey system 104 can utilize supervised learning (i.e., regression and classification), clustering, dimensionality reduction, structured prediction, anomaly detection, neural nets, reinforcement learning, or any other learning models.

In addition to determining the identity of a respondent in act 208 from the sent image from act 206, the digital survey system 104 also determines and associates the sent image from act 206 with a respondent identifier corresponding to the identified respondent. For instance, in one or more embodiments, after the digital survey system 104 determines a respondent by analyzing the sent image from act 206 against the labeled images, the digital survey system 104 can identify the best matched labeled image for the sent image from act 206 and obtain data associated with the labeled image (i.e., such as name, contact information, or a respondent identifier). The digital survey system 104 then associates the sent image from act 206 with the identified data from the matching labeled image.

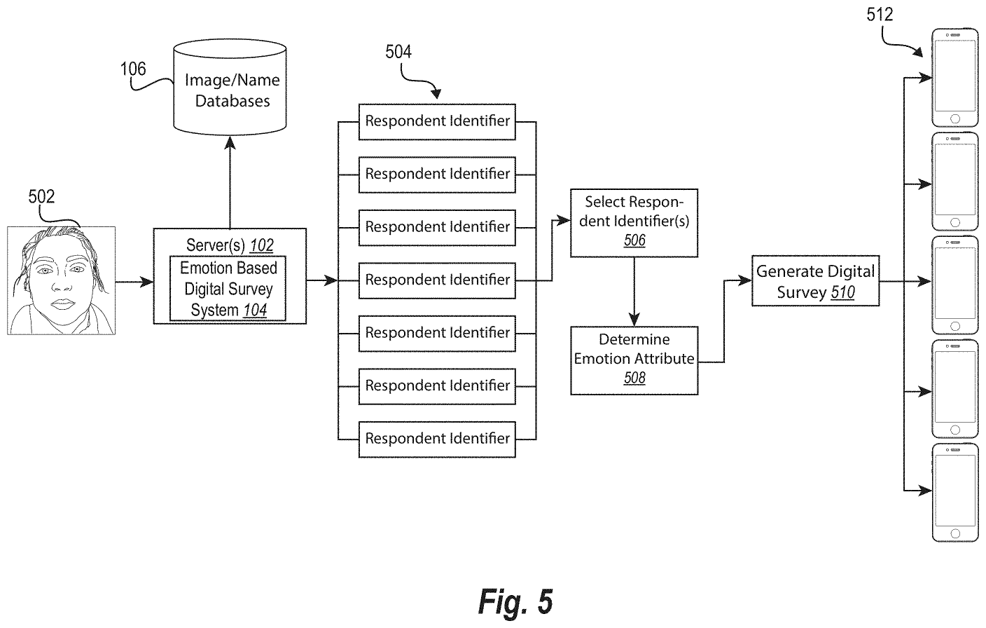

For example, in one or more embodiments, the digital survey system 104 can create an ID for the sent image from act 206 and store the ID on a database with the associated respondent identifier(s) contained in the same entry as the ID for the sent image from act 206. Alternatively, in one or more embodiments, the digital survey system 104 may not have a respondent identifier for the matching labeled image. In such a case, in some embodiments, the digital survey system 104 can utilize the data from the labeled image that matches with the sent image from act 206 to create a new respondent identifier in the system. Furthermore, the digital survey system 104 can associate the sent image from act 206 with the newly created respondent identifier. Moreover, in one or more embodiments, the digital survey system 104 can determine more than one respondent in act 208 from a single sent image (see discussion below in FIG. 5).

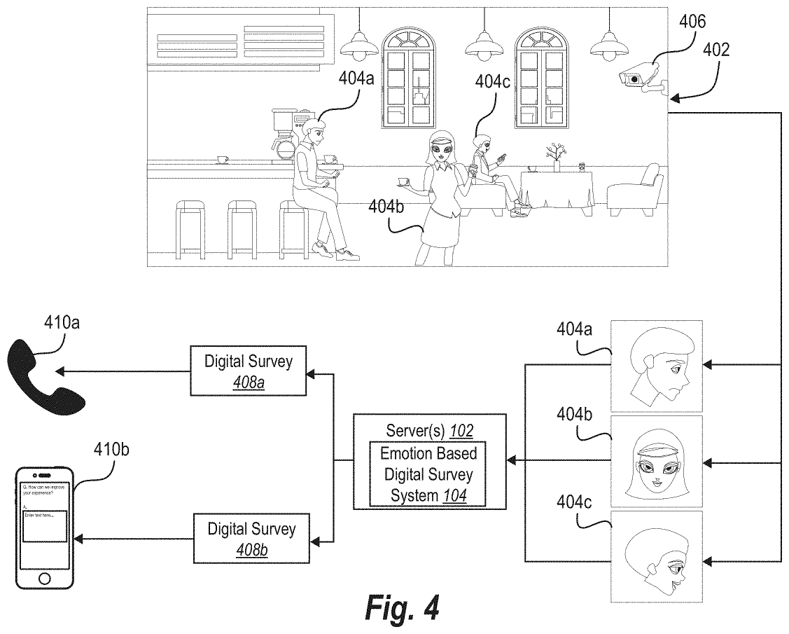

As further illustrated in FIG. 2, the digital survey system 104 analyzes the sent image from act 206 from the capture system 114 to determine an emotion attribute in act 210 associated with the facial features of the respondent in the sent image 206. The digital survey system 104 can analyze the sent image 206 (or any image that is available in the server device(s) 102) by using various facial recognition algorithms, third party software, and/or machine learning models to determine an emotion attribute in act 210. Moreover, after determining the emotion attribute in act 210 from the sent image from act 206, the digital survey system 104 can provide the emotion attribute to a database corresponding with the determined respondent identifier (i.e., from act 208) from the sent image from act 206. In one or more alternate embodiments, the emotion attribute can be determined in act 210 from the sent image from act 206 and stored in the server device(s) 102 in order to generate digital reports based on the emotion attribute (discussed in further detail in FIG. 4).

In one or more embodiments, the digital survey system 104 can utilize facial recognition algorithms or third-party software to determine an emotion attribute in act 210 associated from a sent image from act 206. For example, the digital survey system 104 applies facial recognition algorithms to detect and measure facial features in an image that form facial expressions. In one or more embodiments, the digital survey system 104 utilizes facial recognition algorithms (i.e., the facial recognition algorithms described in act 208 above) to assign unique scores to the sent image from act 206 based on certain facial features (e.g., different weights for eye position, lip movement, brow position, etc.). To illustrate, in some embodiments, the digital survey system 104 assigns unique scores to facial features detected by a facial recognition algorithm, such as a unique score for facial features categorized according to the Facial Action Coding System (“FACS”). In such embodiments, the unique scores correspond to the following emotion categories: anger, contempt, fear, disgust, happiness, neutral, sadness, or surprise.

Moreover, in some embodiments, the unique scores can be weighted. Based on the average, sum, or product of the weighted scores, the digital survey system 104 determines that the survey respondent 120a in the sent image from act 206 expresses a positive emotion, a neutral emotion, or a negative emotion in act 210 (or any type of emotion attribute). Alternatively, in some embodiments, the digital survey system 104 determines that the survey respondent 120a in the sent image from act 206 expresses a strong emotion, a moderate emotion, or a weak emotion based on the average, sum, or product of the weighted scores.

Based on analyzing an image to detect emotions of a respondent, in some embodiments, the digital survey system 104 converts information from the facial recognition algorithms into emotion categories more specific than a positive, neutral, or negative emotion—including, but not limited to, the emotion categories of anger, contempt, fear, disgust, happiness, neutral, sadness, and surprise. For example, the digital survey system 104 determines that the survey respondent 120a in the sent images from act 206 expresses one of the prior emotion categories by using computer vision techniques to perform facial emotion recognition or by using an Emotion API. For example, the digital survey system 104 can also use an Emotion Application Program Interface (“API”), such as Microsoft Corporation's Emotion API, to determine an emotion exhibited by a respondent in the sent image from act 206. Furthermore, in one or more embodiments, the digital survey system 104 can utilize other types of emotion recognition software. For instance, in some embodiments, the digital survey system 104 can utilize, but is not limited to, software provided by Emotient, Visage Technologies AB, nViso, and Eyeris.

Building on the unique scores described above, the digital survey system 104 can adjust a unique score for facial features under FACS that correspond to anger, contempt, fear, disgust, happiness, neutral, sadness, or surprise based on other known respondent information available to the digital survey system 104. For example, in some embodiments, the digital survey system 104 can adjust the unique score based on information such as respondent gender, age, biometric information, and geographic location. Based on the adjusted score, the digital survey system 104 can determine that the one or more scores support a determination that the survey respondent 120a in the sent image from act 206 expresses anger, contempt, fear, disgust, happiness, neutral, sadness, or surprise, or changes the determination to a different emotion category.

Additionally, in some embodiments, the digital survey system 104 can utilize machine learning models to determine an emotion attribute in act 210 associated with a sent image from act 206. As mentioned above (for act 208), machine learning models, in some embodiments, can utilize training data to train a neural network. For instance, in some embodiments, the digital survey system 104 can train a neural network to predict emotion attributes from unlabeled input data (i.e., the sent images from act 206). In one or more embodiments, the digital survey system 104 can train a neural network to predict emotion attributes from training images of persons exhibiting an emotion (i.e., classify the training image by one or more emotion attributes) and compare the predictions to a ground truth determination of the emotion attribute from the same training images. The neural network utilizes the comparison between the predictions and the ground truth determinations to optimize settings to make more accurate predictions on subsequent images. Upon training and optimizing, the neural network can analyze sent images from act 206 to determine an emotion attribute in act 210. Similarly, the digital survey system 104 can utilize the machine learning models from act 208 (i.e., CNN, RNN, classification learning, and other machine learning models).

Upon determining the emotion attribute in act 210 from the image, the digital survey system 104 can store the determined emotion attribute in act 210 in the server device(s) 102. More particularly, in some embodiments, the digital survey system 104 can provide the determined emotion attribute in act 210 to a database with a corresponding respondent identifier for the emotion attribute (i.e., the determined respondent in act 208 from the sent image from act 206). As mentioned above, the digital survey system 104 can store the emotion attribute as an informational representation of various types of emotions. For example, in some embodiments, the emotion attribute can be a set of identifiers that are represented as integers (i.e., 1 for happiness, 2 for sadness, and 3 for anger). The digital survey system 104 can store the determined emotion attributes in act 210 and the determined respondent identifiers from act 208 (i.e., from the sent image from act 206) in a database on the server device(s) 102. To illustrate, in some embodiments, the digital survey system 104 can store the above-mentioned information in a database that includes the determined respondent identifier from act 208, the determined emotion attributes from act 210, other respondent information, and the sent image from act 206 from the capture system 114 for one or more respondents. Moreover, the digital survey system 104 can utilize the information in the database above to generate content for a digital survey in act 212 for a respondent.

As also shown in FIG. 2, and as mentioned above, the digital survey system 104 can utilize the determined respondent identifier from act 208 and the determined emotion attributes from act 210 from the sent image from act 206 to generate content for a digital survey in act 212. In some embodiments, the digital survey system 104 accesses the parameters provided by an administrator device for digital survey content in act 202 to generate content for a digital survey in act 212 based on the determined respondents from act 208 and the determined emotion attributes from the sent image from act 206. As a result, the digital survey system 104 can generate content for a digital survey in act 212 that is personalized for an intended respondent without human intervention. This allows the digital survey system 104 to generate digital surveys in act 212 that experience a higher response rate than some conventional digital survey systems (i.e., resulting in a more efficient use of computational resources) and can better avoid computer-based spam filtering systems in comparison to conventional digital survey systems.

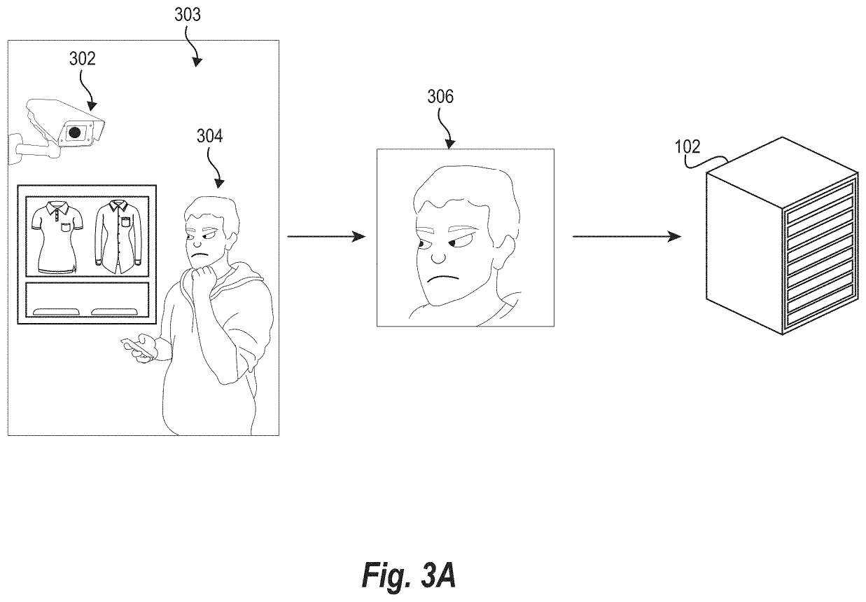

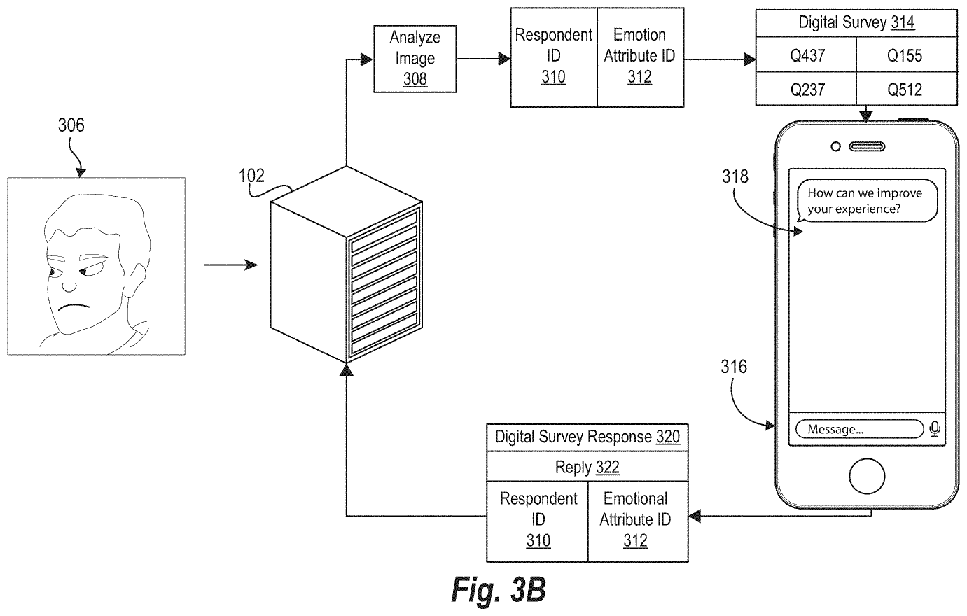

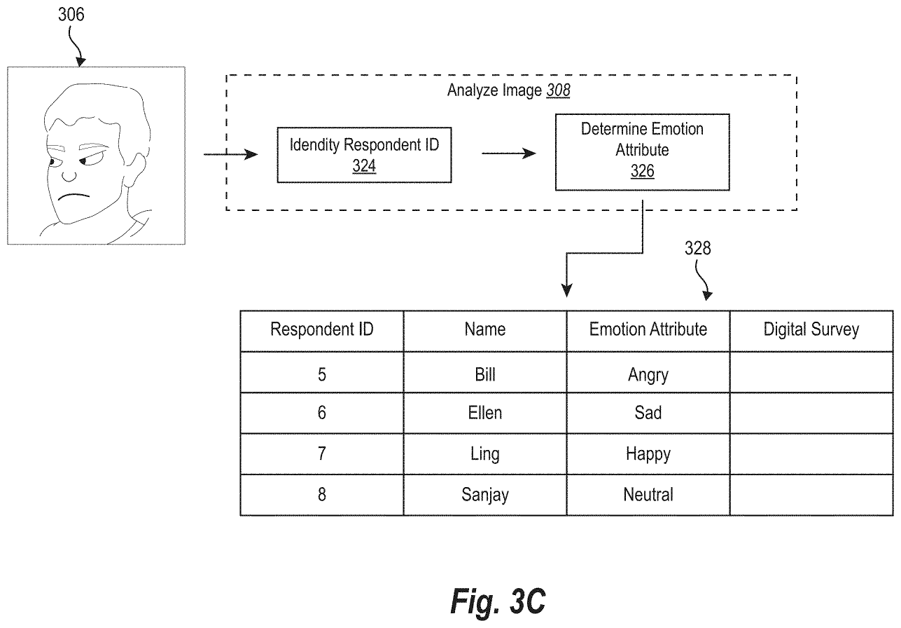

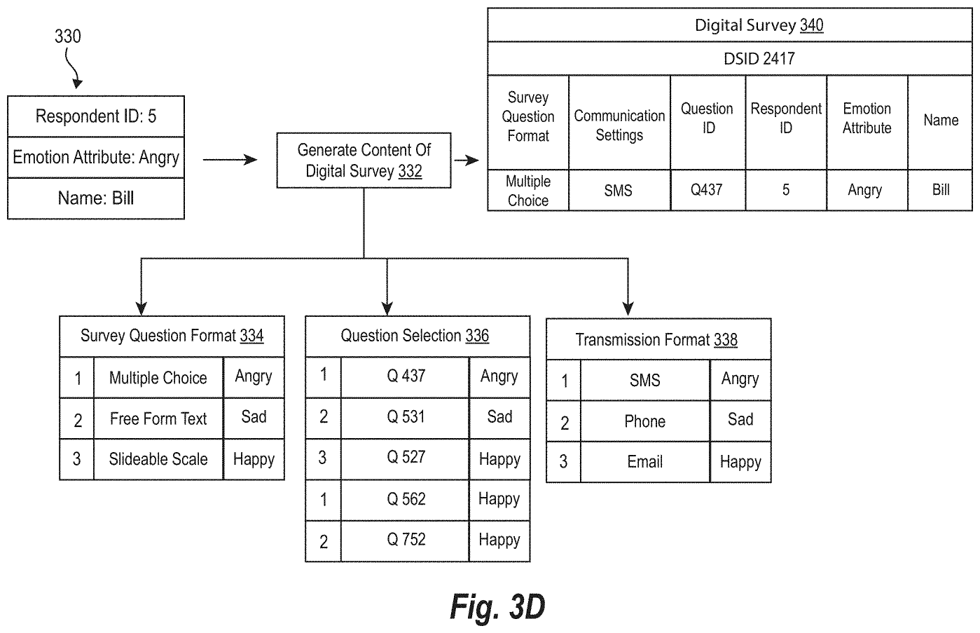

In one or more embodiments, the digital survey system 104 accesses parameters for digital survey content in act 202 as provided by the administrator device 110 to begin generating content for a digital survey in act 212. For instance, as discussed above in act 202, the administrator device 110 can provide digital survey content and communication settings to the digital survey system 104 with predetermined emotion attribute associations (i.e., an administrator decides what digital survey content and/or communication settings are associated with one or more discoverable emotion attributes). The provided digital survey content and/or communication settings parameters in act 202, in some embodiment, are stored in databases that can be accessed by the digital survey system 104 (see FIG. 3D below).

Based on the digital survey content parameters from act 202 from the administrator device 110, the determined respondent identifier from act 208, and the determined emotion attribute from act 210, the digital survey system 104 can generate content for a digital survey in act 212 customized for a respondent based on an associated emotion attribute. For example, the digital survey system 104 can utilize the provided information to select survey questions for a digital survey to send to the respondent. In some embodiments, the digital survey system 104 can select digital survey questions with a corresponding question ID (i.e., Q437), wherein the question ID corresponds to one or more emotion attributes (see FIG. 3D). Furthermore, the digital survey system 104 can determine what digital survey questions to utilize for the respondent by comparing the determined emotion attribute in act 210 associated with the respondent from the sent image from act 206 with the emotion attributes associated with the digital survey questions from act 202 provided by the administrator device 110. The digital survey system 104, in one or more embodiments, can store the selected digital survey questions in a database associated with a respondent identifier (i.e., store the question IDs in a table for the determined respondent from act 208).

Similarly, the digital survey system 104 can also utilize the provided digital survey content parameters from act 202 to select survey question formats for the digital survey. For instance, in some embodiments, the digital survey system 104 can select survey question formats from a table of survey question formats represented with corresponding ID tags (i.e., SQF 153). Furthermore, the survey question formats can correspond to one or more emotion attributes (see FIG. 3D). The digital survey system 104 can determine, in one or more embodiments, a survey question format to utilize by comparing the determined emotion attribute from act 210 from the image with the emotion attributes associated with the survey question formats provided by the administrator device 110 in act 202. Likewise, the digital survey system 104 can also store the selected digital survey question format in a database associated with a respondent identifier.

As used herein, the term “survey question format” refers to structural or informational preferences of a digital survey. In particular, “survey question format” refers to data on how elements of a digital survey (i.e., the content) should be represented on a client device. For example, types of survey question formats include, but are not limited to, multiple-choice, slider, open-ended, ranking, scoring, summation, demographic, dichotomous, differential, cumulative, dropdown, matrix, net promotor score (NPS), single textbox, heat map, and any other type of formats that can be represented to a respondent to invoke a response from the respondent. In one or more embodiments, when one or more answer choices are available for a digital survey question, a survey question format may include a question portion as well as an available answer choice portion that corresponds to the survey question. For example, when describing a multiple-choice survey question, the survey question format may include both the question itself as well as the multiple-choice answers associated with the multiple-choice question.

Additionally, the digital survey system 104 can also utilize the provided digital survey content parameters from act 202 from the administrator device 110 to select communication settings for the digital survey when generating content for a digital survey in act 212. Similar to the digital survey questions and digital survey question formats, the digital survey system 104, in some embodiments, can select communication settings for the digital survey from a database comprising communication settings (see FIG. 3D) and corresponding emotion attributes for the communication settings. Likewise, the digital survey system 104 can also store the selected communication settings in a database associated with a respondent identifier.

As used in this disclosure, the term “communication settings” or “distribution channel settings” refers to one or more preferences on how the digital survey system distributes a digital survey. For example, the term “communication settings” refers to one or more data elements representing where, how, and when the digital survey will provided to a respondent. In some embodiments the communication settings can include, but are not limited to, a selection of a type of client device on which to provide the digital survey, a scheduled time for providing the digital survey, a selection of the contact information for a respondent, storage settings for the digital survey, refresh times for the content of the digital survey, and transmission formats. The transmission format (or distribution channel) can include the manner in which the digital survey is transmitted to the respondent such as a possible client device. For example, the transmission format can be, but is not limited to, a phone call, an SMS, an MMS, an E-mail, an instant message, a web interface, or a social media post. Specifically, the communication settings can be a data set of preferences for a digital survey, represented as values in a database, such as information indicating that the digital survey will be provided to the respondent on the respondent's mobile phone (using the respondent's mobile phone number) through SMS, at 2:00 PM EST on Monday, wherein the response to the digital survey will be sent back to a particular IP address, and that the digital survey will expire after 10 hours.

Additionally, in some embodiments, after selecting the digital survey questions, the digital survey question format, and the digital survey communication settings based on the emotion attributes, the digital survey system 104 can generate a digital survey in act 212 for a respondent. For example, the digital survey system 104, in some embodiments, can generate a digital survey in act 212 by creating a table comprising the respondent identifier, respondent information, selected digital survey questions, selected digital survey question format, and the digital survey communication settings (see FIG. 3D). The generated digital survey from act 212, in one or more embodiments, can then be stored in the server device(s) 102 by the digital survey system 104.

After generating a digital survey in act 212, the digital survey system 104 performs act 214 of providing the generated digital survey to some or all of the respondent devices 116, as illustrated in FIG. 2. In one or more embodiments, the digital survey system 104 can provide the generated digital survey from act 214 to a respondent device 116. When performing act 214, the digital survey system 104 may distribute a generated digital survey (including one or more digital survey questions) through any suitable transmission format (i.e., based on the communication settings).

As further shown in FIG. 2, after receiving the generated digital survey in act 214, in one or more embodiments, the respondent devices 116 perform act 216 of providing a response for the digital survey to the digital survey system 104 (as discussed in FIG. 1). Moreover, the digital survey system 104 can store the digital survey response provided by the respondent devices in act 216 as digital survey results on server device(s) 102.

As used in this disclosure, the term “digital survey response” (or sometimes simply “survey response” or “response”) refers to any type of electronic data representing a response provided to a digital survey. Depending on the digital survey content type, the digital survey response may include, but is not limited to, a selection, a text input, an indication of an answer, an actual answer, and/or an attachment. For example, a response to a multiple-choice question may include a selection of one of the available answer choices associated with the multiple-choice question. As another example, a response may include a numerical value, letter, or symbol that corresponds to an available answer choice. In some cases, a response may include a numerical value that is the actual answer to a corresponding survey question. In addition, a survey response may include other information associated thereto such as, for example, geographical information pertaining to the location of the respondent, a device ID associated with the device by which the respondent responds to the digital survey question, or other metadata associated with respondent/user input.

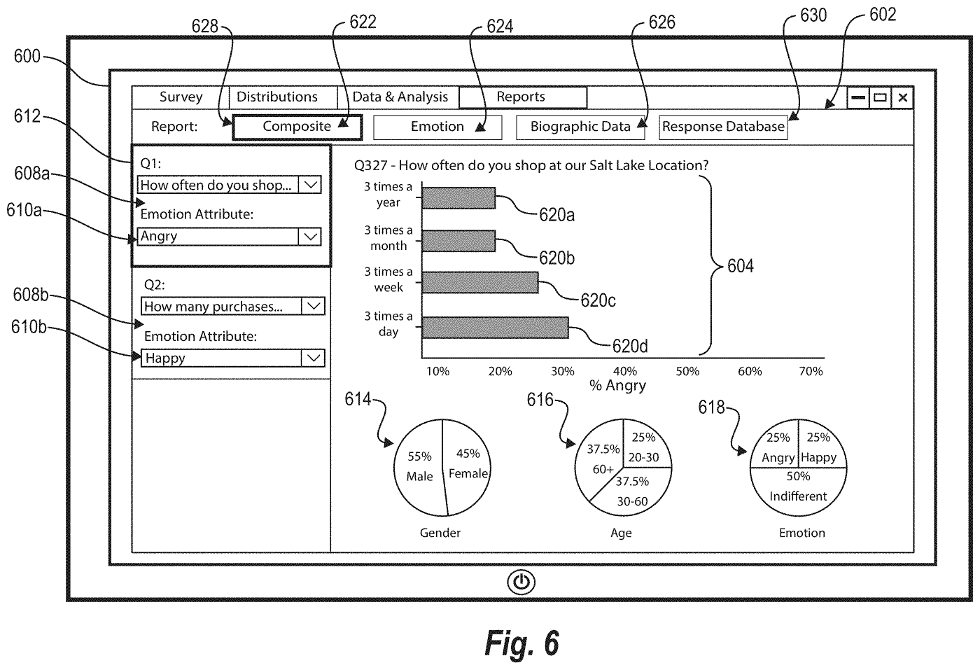

The term “digital survey result” (or the term “survey result” or simply “result”) refers to a representation of information acquired from a digital survey response. A survey result can include a simplified representation of a sentiment, opinion, impact, effectiveness, or other information expressed by a respondent in a survey response. In particular, survey results can refer to a report of customer feedback ratings or a summary of poll results based on extracting or otherwise synthesizing quantitative and/or qualitative information from a received survey response. In some embodiments, the digital survey system 104 can optionally generate a digital survey report in act 218 (or an emotion based digital report) and provide the digital survey report in act 220 to the administrator device 110 (as discussed in FIG. 6).

FIGS. 3A-3D illustrate an example embodiment of the digital survey system 104. Specifically, FIGS. 3A-3D illustrate an embodiment of the digital survey system 104 in which a capture system captures an image of a person in a retail store, sends the image to the digital survey system 104 (via server device(s) 102) in order to generate a digital survey based on the emotional attribute of the person in the sent image, and receives a response from the respondent.

FIG. 3A illustrates an example embodiment, in which a capture system captures an image of a person and provides the image to the digital survey system 104 (via server device(s) 102). For example, the capture system 114 can comprise a camera 302 located in a retail store 303. Furthermore, the camera 302 can capture images of respondents (i.e., shoppers) within the retail store 303. As shown in FIG. 3A, the camera 302 can capture an image of the seemingly upset respondent 304 and produce an image 306 of the shopper. Moreover, the capture system 114 can provide the produced portrait image 306 of the shopper to a server device(s) 102. As discussed above in FIG. 2, the digital survey system 104 can utilize many types of capture device and can be located in many types of setting and are not limited to the example illustration of FIGS. 3A-3D.

Furthermore, FIG. 3B illustrates an example embodiment of the digital survey system 104. The example embodiment of the digital survey system 104 can receive the image 306 on server device(s) 102. Additionally, the digital survey system 104 can determine a respondent identifier 310 and an emotion attribute ID 312 for image 306 of the respondent by analyzing the image 308. In one or more embodiments, the digital survey system 104 can analyze the image 308 by the various methods described above in FIG. 2 to determine a respondent identifier 310 and to determine an emotion attribute ID 312 corresponding to the respondent.

As further shown in FIG. 3B, after the digital survey system 104 determines the respondent identifier 310 and an emotional attribute ID 312 for the image 306, the emotion based digital survey system can generate a digital survey 314 based on the respondent identifier 310 and the emotion attribute ID 312. For instance, the digital survey 314 can include information customized for the respondent, such as a set of customized survey questions based on the emotion attribute ID 312 and other information associated with the respondent. As shown in FIG. 3B, the digital survey system 104 can generate and/or select custom survey questions Q437, Q155, Q237, and Q512 representing different digital survey questions that were selected based on the respondent identifier 310 and the emotion attribute ID 312. For instance, each of the questions selected were associated with an emotion attribute ID that corresponds with the emotion attribute ID 312 corresponding to the image 306.

Additionally, the digital survey system 104 in FIG. 3B can provide the generated digital survey 314 to a respondent device 316 of the seemingly upset respondent 304. In the current example illustration, the digital survey system 104 has determined the respondent device 316 to be a mobile phone and has determined the transmission format to be an SMS message. The respondent 304 can respond to the provided digital survey (e.g., the SMS message 318) on the respondent device 316 and send a digital survey response 320 to the server device(s) 102 (as described in FIGS. 1-2). The digital survey response 320, in one or more embodiments, can include a reply 322 (e.g., text input by the respondent) and respondent information such as the respondent identifier 310 and emotional attribute ID 312. The digital survey system 104 can store and maintain the digital survey response 320.

Moreover, FIG. 3C illustrates an example embodiment in which the digital survey system 104 analyzes the image 308 to determine a respondent identifier 324 and determine an emotion attribute 326 from the portrait image 306 of the shopper and stores the determined information in a respondent database 328. Upon identifying the respondent ID 324 and determining the emotion attribute 326 associated with the image 306, the digital survey system 104 can insert the determined information into a database 328 for every image 306 that the digital survey system 104 receives by the capture system 114. For instance, as shown in FIG. 3C, the digital survey system 104 can store the determined information from the image 306 as respondent ID 5 (an ID associated with a respondent named Bill) and associating an emotion attribute of “Angry” with the respondent in the image 306. Furthermore, once generated, the digital survey system 104 can also provide an identifier for a generated digital survey (discussed in FIG. 3D) in database 328.

After determining the emotion attribute and respondent identifier for the respondent 304, the digital survey system 104 can generate a digital survey for the respondent 304 by generating an assortment of content available on the server device(s) as shown in FIG. 3D. For example, the digital survey system 104 can utilize the determined respondent information 330 for the image 306 to generate content of a digital survey 332 (i.e., a respondent identifier of 5, an emotion attribute as “Angry,” and the name Bill). The digital survey system 104, in an example embodiment, can access various databases such as the survey question format database 334, the question selection database 336, and the transmission format database 338 to generate content of a digital survey 332. For example, the digital survey system 104 can, based on the emotion attribute “Angry,” select the corresponding content from the various databases 334-338. For example, and as shown in FIG. 3D, the digital survey system 104 can select the multiple choice format from the survey question format database 334 (e.g., based on the question format being associated with the emotion attribute of “Angry”), question ID 437 from the question selection database 336 (e.g., based on the question format being associated with the emotion attribute of “Angry”), and the SMS format from the transmission format database 338 (e.g., based on the transmission format being associated with the emotion attribute of “Angry.”). In some embodiments, the survey question format database 334, the question selection database 336, and the transmission format database 338 are all part of a single database within the digital survey system 104.

After generating the content of a digital survey 332 based on the respondent information 330 determined from the image 306, the digital survey system 104 can organize the generated content into a database that represents a digital survey 340. For instance, in the example illustration, the digital survey 340 can comprise or be associated with the identified content from databases 334-338, the respondent information 330, other communication settings, and a digital survey ID (“DSID”). The digital survey system 104 can provide the generated digital survey 340 to a respondent device 316 and the digital survey system 104 and/or the respondent device 316 can utilize the data in the digital survey 340 to generate a graphical user interface to administer the customized digital survey 340 on the respondent device 316.

Although the example embodiment in FIG. 3 illustrates the digital survey system 104 operating in a retail store environment, the digital survey system 104 can be utilize in other situations. For instance, the digital survey system 104 can be utilized in restaurants and food/beverage establishments (i.e., cafes, fast food restaurants, and grocery stores). Furthermore, the digital survey system 104 can be used in other situations such as, but not limited to, traffic cameras, universities, workplace environments, and airports. Moreover, the digital survey system 104 is not limited to providing surveys.

In some embodiments, the digital survey system 104 can provide offers or coupons to a person/respondent based on the determined emotion attributes. Furthermore, the digital survey system 104 can assist with suicide prevention and to address depression/mental disorders, more generally, on university campuses or workplaces by notifying university/workplace administrators to speak with persons determined by the digital survey system 104 that require assistance based on the emotion attributes of the persons. In other alternate embodiments, the digital survey system 104 can generate digital surveys 212 and/or generate digital survey reports 218 for a third party (i.e., administrators of third-party corporations, supervisors in workplaces, or administrators at universities). Likewise, in some embodiments, the digital survey system 104 can provide the generated digital surveys 214 and/or provide digital survey reports 220 (generated from an image of a respondent 206) to other persons than the respondent in the sent image 206.

In addition to FIGS. 3A-3D, the digital survey system 104 can determine emotion attributes for more than one person in an environment. Moreover, in some embodiments, the digital survey system 104 can generate digital reports based on emotion attributes without utilizing and/or determining respondent identities. In particular, FIG. 4 illustrates an example embodiment in which the digital survey system 104 determines identities and emotion attributes for multiple respondents in a cafe environment 402 and generates digital survey content for multiple respondents in the café environment 402. As shown in FIG. 4, a capture system (i.e., a camera) 406 can capture images of respondents (or persons) 404a-404c that are dining in a café 402. Moreover, the capture system 406 can provide the images of respondents 404a-404c to the server device(s) 102 that, in some embodiments, host the digital survey system 104. The digital survey system 104 can analyze the images of respondents 404a-404c to determine respondent identifiers and emotion attributes of respondents 404a-404c (as discussed above in FIGS. 1-3).

Furthermore, as shown in FIG. 4, the digital survey system 104 can generate digital surveys 408a-408b (as discussed in FIGS. 1-3) based on the determined respondent identifiers and emotion attributes from the images of respondents 404a-404c. For instance, in the example embodiment, the digital survey system 104 can determine an emotion attribute of “Sad” for respondent 404a, an emotion attribute of “Neutral” for respondent 404b, and an emotion attribute of “Happy” for respondent 404c. Based on the emotion attribute, the digital survey system 104 can generate a different digital surveys 408a-408b for the respondents 404a-404c. For example, the digital survey system 104 can generate, based on the emotion attribute associated with respondent 404a, a digital survey 408a with questions such as: “how can we improve your experience?” The digital survey system 104 may further determine that the generated digital survey 408a will be provided by phone call 410a (the distribution channel) to the respondent 404a based on the emotion attribute associated with respondent 404a (i.e., a phone call 410a by a customer service agent based on a request from the digital survey system 104 to the customer service agent with a set of provided survey questions by the digital survey system 104). Furthermore, the digital survey system 104 can generate a separate digital survey 408b for respondent 404c based on the determined emotion attribute of respondent 404c. For instance, the digital survey 408b can contain the survey question “tell us what you enjoyed about your experience.” The digital survey system 104 can also determine that the digital survey 408b will be provided to the respondent 404c by SMS message 410b based on the determined emotion attribute of respondent 404c.

Additionally, in some embodiments, the digital survey system 104 can determine that a digital survey will not be generated and will not be provided to a respondent based on the emotion attribute of a respondent. For example, as illustrated in the example embodiment FIG. 4, the digital survey system 104 can determine to not provide a digital survey to the respondent 404b based on the emotion attribute (“Neutral”) of the respondent 404b. The digital survey system 104, in one or more embodiments, can generate a variety of combinations of digital surveys based on different emotion attributes for different respondents in an environment.

Moreover, in some embodiments, the digital survey system 104 can generate a group based analysis instead of surveying individual respondents. For instance, in the example embodiment of FIG. 4, the digital survey system 104 can analyze the images of one or more respondents 404a-404c without utilizing the respondent identifiers for the respondents 404a-404c. In some embodiments, the digital survey system 104 does not determine the respondent identifiers for the respondents 404a-404c, but rather determines an emotion attribute for the respondents 404a-404c and uses the emotion attribute directly to provide a response to a digital survey or otherwise create response data. For example, the digital survey system 104 can determine the emotion attributes of the respondents 404a-404c and the location of the respondents 404a-404c in the café 402 by analyzing the images of respondents 404a-404c captured by the capture system 406.

Accordingly, the digital survey system 104 can utilize the determined locations and emotion attributes of the respondents 404a-404c to generate data that is reported to the survey system. For example, the digital survey system 104 can associate a location of a respondent with the respondent's emotion attribute and record the paired data as a response to a customer survey addressing customer satisfaction with the design and layout of the café. Based upon collection of this information, the digital survey system 104 can generate reports that indicate customer satisfaction as a whole (e.g., café location independent) or customer satisfaction based on location (e.g., taking into account the location of a respondent within the café). In some embodiments, the location component may be associated with different geographic locations (e.g., specific geographic locations associated with different café s), or as just described, the location component can be associated with different locations within a single café.

The digital survey system 104, in other embodiments, can utilize the emotion attributes of the images of respondents 404a-404c to determine a variety of statistics for the environment setting in which the capture system 406 is capturing images. For example, in one simple embodiment, the digital survey system 104 can keep track of how many people experience certain emotions when visiting the café 402 (i.e., 45% of the people visiting the café 402 are sad and 55% of the people visiting the café 402 are happy). Additionally, as discussed above, the digital survey system 104 can generate a group analysis in various environment settings and is not limited to the example embodiment of FIG. 4.

As mentioned above, the digital survey system 104 can determine an identity of a respondent by analyzing an image of a person (as a respondent identifier in some embodiments). Further, as illustrated in FIG. 5, the digital survey system 104, in some embodiments, can determine one or more possible respondent identifiers from an image by utilizing a confidence level when analyzing an image. As used herein, the term “possible respondent identifiers” refers to one or more respondent identifiers that potentially relate to a respondent depicted within an image. For example, the digital survey system 104 can retrieve more than one possible respondent identifiers for an image when determining an associated respondent identifier for the image based on determining confidence levels that one or more respondent identifiers correspond to a depicted respondent in an image.

For instance, and as shown in FIG. 5, the digital survey system 104 can analyze an image 502 by comparing the image to images in an image database 106 (as discussed in detail above with respect to FIGS. 1-3) and determine one or more possible respondent identifiers 504. The one or more possible respondent identifiers 504 can comprise all the respondent identifiers that are identified by the digital survey system 104 to resemble the person in the image 502. In some embodiments, the digital survey system 104 can identify existing possible respondent identifiers 504 and also create new possible respondent identifiers 504 based on the information gathered by the digital survey system 104 when analyzing the image 502 with the image database 106 (i.e., discovering another person in the database that resembles the person in the image 502 but does not have a respondent identifier in the server device(s) 102).

In one or more embodiments, the digital survey system 104 can select one or more respondent identifier(s) 506 from the set of possible respondent identifiers 504, as shown in FIG. 5. For example, the digital survey system 104 can select respondent identifiers 506 by determining and assigning a confidence level to each possible respondent identifier 504. As used in this disclosure, the term “confidence level” refers to a value that is utilized to make decisions by a computer system. In particular, the term “confidence level” refers to a value that can be compared to a threshold value, or to other values, by a computing system, before determining whether an action should be taken by a system. For instance, the confidence level can include a value that designates the reliability of a match of a respondent depicted in an image 502 with the possible respondent identifier(s) 504.

In some embodiments, the value designating the reliability of the match can be compared to a threshold value to determine whether the image 502 should be associated with the possible respondent identifier 504. For example, in some embodiments, the digital survey system 104 can analyze an image and determine that seven unique possible respondent identifiers 504 might be a match for the respondent depicted in image 502. Furthermore, the digital survey system 104 can determine a confidence level for each possible respondent identifier 504 relative to the image 502. For example, based on comparing facial measurements, facial features, and other measurements between the image 502 and an image of a respondent in a respondent database, as described above with respect to FIG. 2, the digital survey system 104 can generate a value or score representing the likelihood that the respondent in the image matches a respondent ID. For explanation purposes, the confidence value can be a value from 0-10, with 10 being a 100% confidence level and 0 a 0% confidence level. Other embodiments can use other value systems.

Based on the confidence levels, the digital survey system 104 can proceed to select one or more respondent IDs based on a selection algorithm. For example, the selection algorithm can automatically select a single respondent ID to associated with a respondent depicted in the image 502 if the confidence level of a particular respondent ID is 8 or above (e.g., based on a scale of 0-10). In addition, the selection algorithm can select a single respondent ID if a difference between the highest confidence level of a respondent ID is above a difference threshold of the next highest confidence level of a respondent ID. For instance, if the highest confidence level is a 7, and the next highest is a 3, and the difference threshold is 3, then the respondent ID associated with the confidence level of 7 would be selected.

In other embodiments, the selection algorithm allows for the selection of multiple respondent IDs from respondent IDs 504. For example, in the event that five respondent IDs are at or above a threshold confidence level of 8, the digital survey system 104 can select all five respondent IDs. In addition, if the five highest confidence levels are all between 5-6, then the digital survey system 104 can select all five respondent IDs. In this way, the digital survey system 104 can select one or more respondent IDs based on maximizing the likelihood of identifying the actual respondent depicted within the image 502.

After selecting the respondent identifiers 506, the digital survey system 104 can determine the emotion attribute 508 by analyzing the image 502 and generate a digital survey 510 for the five respondent identifiers 506 based on the determined emotion attribute 508 (as discussed in FIGS. 1-3 above). Furthermore, the digital survey system 104 can provide the generated digital survey 510 to the selected respondent identifiers 506 on possible respondent devices 512 for each of the selected respondent identifiers 504. As used in this disclosure, the term “possible client devices” refers to one or client devices that can be selected by the digital survey system 104. For example, the digital survey system 104 can include information of more than one possible client device for a respondent when determining the communication settings for a digital survey. Furthermore, as used in this disclosure, the term “possible respondent devices” refers to one or more possible client devices utilized by a respondent that can be selected by the digital survey system 104 to display a digital survey.

In some embodiments, the digital survey system 104 can generate a digital survey based on the confidence level and presence of possible respondent identifier(s) 504 (in addition to determined emotion attributes 508). For example, in some embodiments, the digital survey system 104 can generate a modified survey question or select a different survey question because of the presence of more than one possible respondent identifier 504. For example, if there are several possible respondents, the digital survey question can select fewer questions, or alternatively, select additional questions. Also, based on selecting several possible respondents, the digital survey system may discount or ignore information about the emotion attribute since it is possible that while the respondent depicted in the image may have a particular emotion attribute, one or more of the possible respondents do not relate with that emotion attribute. Thus, for example, for a respondent ID associated with lower confidence levels, the digital survey system 104 can generate a more generic survey that discounts or does not consider the emotion attribute corresponding to the image 502.

In one or more embodiments, the digital survey system 104 can select an identifying question based on selecting multiple respondent identifiers, where the identifying question asks a question related to whether the respondent visited the location captured in the image 502 on a particular date and time. Thus, based on the responses to the identifying question from each of the possible respondents, the digital survey system 104 can determine which of the possible respondents is the actual respondent. For example, and as shown in FIG. 5, the digital survey system 104 can send the five possible respondents a digital survey that includes the question, “Did you visit [location] on [date] and [time]?” where the [location], [date], and [time] is accessed via metadata associated with the image. Based on the responses from each of the five possible respondents, the digital survey system can determine which of the five possible respondents is the actual respondent in the image 502.

In addition, in some embodiments, the digital survey system can generate a branching logic survey dependent on the identifying question for a digital survey sent to multiple possible respondents. For example, the identifying question can represent a fork in a branching digital survey and can provide a first group of questions based on an affirmative response to the identifying question or provide a second group of questions based on a negative response to the identifying question. In particular, in the event that a first respondent from the group of possible respondents confirms that he visited the location at a particular date and time, then the digital survey system can cause a first group of questions to be provided on the respondents' device that are specific to the emotion attribute and respondent ID. On the other hand, when a second respondent from the group of possible respondents confirms that the second respondent did not visit the location at the date and time, then the digital survey system can cause a second group of questions to be provided on the second respondents device that are generic and do not account for the emotion attribute or other specifics related to the image 502. In some cases, after a potential respondent provides a negative response to an identifying question, the digital survey ends (e.g., no further questions are provided).

As noted above, in addition to determining emotion attributes from analyzed images and generating a digital survey based on the determined emotion attributes, in some embodiments, the digital survey system 104 generates digital survey reports that comprise digital survey results, digital survey responses, respondent information, or any other response information within a database (i.e., a database on the server device(s) 102). Additionally, a digital survey report can identify specific respondent characteristics (i.e., emotion attributes) that correspond to responses by one or more survey respondents to specific digital survey questions. In some embodiments, the digital survey system 104 can generate an emotion based digital report, as shown in FIG. 6. The term “digital survey report” refers to any arrangement of survey results. Specifically, the term “digital survey report” refers to a compilation or organized representation of the survey results. For example, a digital survey report can include, but is not limited to, graphs, charts, lists, or calculations representing one or more survey results.

Furthermore, as used in this disclosure, the term “emotion based digital report” refers to any arrangement of determined emotion attributes to generate a report. More specifically, an emotion based digital report 600 can include a compilation or organized representation of one or more determined emotion attributes from one or more persons determined from images of the one or more persons (i.e., respondents). As shown in FIG. 6, for example, the emotion based digital report 600, can include a representation of the percentage of persons that are associated with an emotion attribute in a particular location and can be represented as, but is not limited to, a graph, a chart, a list, or calculations representing the emotion attributes in association with the one or more persons.

As shown in FIG. 6, the digital survey system 104 provides an emotion based digital report 600 for display within a graphical user interface on a screen 602 of the administrator device 110 for the survey administrator 108. The emotion based digital report 600 includes a response graph 604 that represents a collection of responses to a first survey question (“How often do you shop at our Salt Lake location?”). FIG. 6 illustrates a representation of the first survey question as a first survey question thumbnail 608a, as well as a second survey question as a second survey question thumbnail 608b. The first survey question thumbnail 608a and the second survey question thumbnail 608b also include a first emotion attribute selector 610a and a second emotion attribute selector 610b. As shown, a question indicator 612 surrounds the first survey question thumbnail 608a to indicate that the responses represented in the response graph 604 are responses to the first survey question.

In addition to the response graph 604, the emotion based digital report 600 further includes a respondent-gender chart 614, a respondent-age chart 616, and a respondent-emotion chart 618. Each of the charts 614, 616, and 618 include a graphical representation of respondent characteristics exhibited by survey respondents while responding to the first survey question (e.g., while a respondent device presented the first survey question). By generating the digital survey questions and other digital survey content with determined emotion attributes, the digital survey system 104 can report digital survey responses based on respondent characteristics such as emotion attributes.

As further shown in FIG. 6, the respondent-gender chart 614, the respondent-age chart 616, and the respondent-emotion chart 618 include graphical representations of respondent gender, respondent-age, and emotions exhibited by survey respondents when the digital survey question was generated for the respondent. Specifically, the respondent-gender chart 614 indicates the percentage of survey respondents that responded to the first survey question that are male (55%) and female (45%). The respondent-age chart 616 indicates the percentage of survey respondents that responded to the first survey question that are 20-29 years old (25%), 30-59 years old (37.5%), and over 60 years old (60%). Furthermore, the respondent-emotion chart 618 indicates that a certain percentage of survey respondents were angry (25%), happy (25%), and neutral (50%) when the first survey question was generated for the respondent.

As suggested above, the digital survey system 104 optionally generates an emotion based digital report 600 that includes a response graph 604 and emotion based digital report 600 associated with different survey questions. For example, as shown in FIG. 6, when the digital survey system 104 receives an indication that the survey administrator 108 selects the second survey question thumbnail 608b, the digital survey system 104 causes the administrator device 110 to update the emotion based digital report 600 to include a response graph 604 and respondent-characteristic charts (i.e., charts 614-618) associated with the second survey question.

Moreover, in addition to generating emotion based digital report 600 for different survey questions, the digital survey system 104 optionally generates an emotion based digital report 600 that includes respondent-characteristic charts associated with survey respondents who replied in a same or similar way to a survey question. For example, in some embodiments, the digital survey system 104 generates an emotion based digital report 600 that includes respondent-characteristic charts for survey respondents who selected a same answer choice for a multiple-choice question. As shown in FIG. 6, when the digital survey system 104 receives an indication that the survey administrator 108 selects a first answer option 620a, a second answer option 620b, a third answer option 620c, or a fourth answer option 620d the digital survey system 104 causes the administrator device 110 to update the emotion based digital report 600 to include respondent-characteristic charts that represent respondent characteristics exhibited by survey respondents who selected a first answer option 620a (i.e., “3 times a year”), a second answer option 620b (i.e., “3 times a month”), a third answer option 620c (“3 times a week”), or a fourth answer option 620d (i.e., “3 times a day”), respectively.

Furthermore, the digital survey system 104 can receive an indication that the survey administrator 108 selects an emotion attribute from the first emotion attribute selector 610a. The digital survey system 104, in some embodiments, generates an emotion based digital report 600 based on the selected emotion attribute for the first survey question. For example, the response graph 604 represents the percentage of respondents associated with the emotion attribute “Angry” that selected a certain response from responses 620a-620d for the first survey question. Indeed, the digital survey system 104 can filter (or withhold the inclusion of) other digital survey responses that are not associated with the selected emotion attribute.

In addition to generating emotion based digital reports 600 for survey respondents answering in the same way or with a common emotion attribute, the digital survey system 104 provides selectable options to generate digital survey reports showing different respondent characteristics in isolation. As shown in FIG. 6, for example, the emotion based digital report 600 includes a composite-report option 622, a respondent-emotion-report option 624, and a biographic-report option 626. A report indicator 628 surrounds the composite-report option 622 to indicate that the emotion based digital report 600 currently includes a composite of different respondent characteristics. Each of the charts 614, 616, and 618 represent the different respondent characteristics.

When the digital survey system 104 receives an indication that the survey administrator 108 selects the respondent-emotion-report option 624 or the biographic-report option 626, the digital survey system 104 updates the emotion based digital report 600 to include data corresponding to a respondent emotion or demographic classification, respectively. But in each case, the updated emotion based digital report shows data representing a single respondent characteristic. For example, the respondent-emotion-report option 624 triggers the digital survey system 104 to update the emotion based digital report 600 to include the respondent-emotion chart 618 without the respondent-gender chart 614 or the respondent-age chart 616. In some embodiments, the emotion based digital report can comprise other respondent characteristic options.

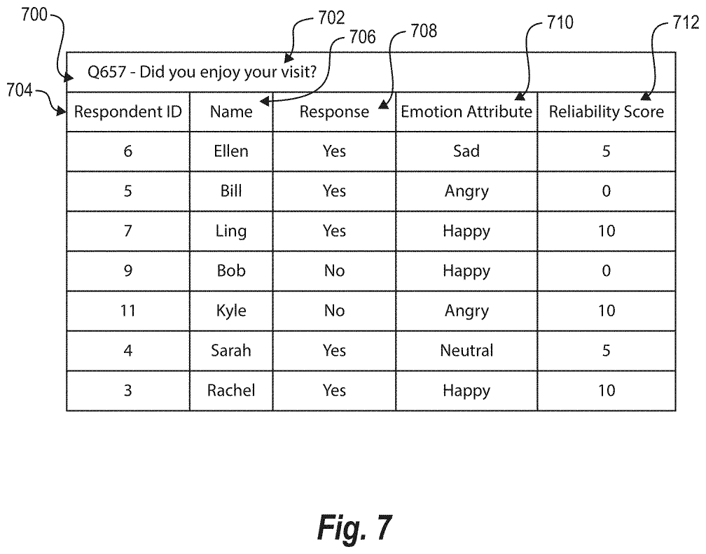

Additionally, in some embodiments, the digital survey system 104 generates a report that depicts a response database for a digital survey. In such embodiments, and as described above, the response database is sortable by any category. As shown in FIG. 6, for example, the emotion based digital report 600 includes a response-database-report option 630. When the digital survey system 104 receives an indication that the survey administrator 108 selects the response-database-report option 630, the digital survey system 104 generates a report showing a response database that categorizes the underlying response data for a digital survey. In some embodiments, the underlying response data can be categorized by an emotion attribute. For example, upon receiving an indication that the survey administrator 108 selects the response-database-report option 630, the digital survey system 104 optionally generates a respondent-characteristic report with a graphical representation of the response database (as shown in FIG. 7 below).

Turning now to FIG. 7, the digital survey system 104 can also determine the reliability of digital survey responses from respondents based on the emotion attribute associated with the respondent identifier of the respondent. FIG. 7 provides an example illustration of a response database 700 wherein the digital survey system 104 can determine a reliability score 712 for a response 708 provided by a respondent (with a respondent ID 704 and a name 706). As used in this disclosure, the term “reliability score” refers to a quantifiable measurement of the reliability of a digital survey response. In particular, the term “reliability score” refers to a quantifiable measure of how a response compares (in terms of reliability) to the emotion attribute associated with digital survey of the response. Specifically, the reliability score can include, but is not limited to, a numerical value, wherein a digital survey response achieves a higher numerical value (i.e., a higher reliability score) if the digital survey response positively matches with the associated emotion attribute of the respondent. For instance, the digital survey system 104 can compare the response 708 and the emotion attribute 710 to determine a reliability score. In some embodiments, the emotion based digital survey system receives indication from a survey administrator 108 as to what emotion attributes 710 are generally associated with particular multiple choice responses 708. For example, the emotion based digital survey system can determine a reliability score of 10 out of 10 (i.e., a high reliability score) when a respondent 704 provides that the respondent enjoyed his visit (i.e., the response 708) to the digital survey question 702 and the emotion attribute 710 of the respondent during the visit is equivalent to the emotion of happiness. In instances where a response is a free-text response, the digital survey system can determine a sentiment score associated with the text response, and then compare the sentiment score to the emotion attribute to determine a reliability level. For example, the digital survey system can generate a sentiment score for a response by analyzing the text to identify words associated with positive comments (e.g., good, great, fantastic, liked, etc.) or words associated with negative comments (e.g., bad, horrible, disliked, hated, etc.). In addition, the digital survey system can consider other factors of the response to generate a sentiment score, such as length of text, length of sentences, number of positive words, number of negative words, or other textual characteristics known in the art to indicate sentiment.

Once the digital survey system determines a sentiment score (or other indication or value), the digital survey system 104 can compare the sentiment of the response to the emotion attribute and determine whether or not the sentiment of the response aligns with the emotion attribute. For example, the digital survey system can determine that a particular response has a negative sentiment indicating that the respondent is unhappy. However, if the emotion attribute associated with the image of the respondent is indicates happy, then the reliability of the response is discounted. In some embodiments, the reliability is based on the degree of difference between a sentiment score and a score associated with an emotion attribute.

Furthermore, the digital survey system 104 can also generate a digital report (as shown in FIG. 6) with a reliability score for a digital survey or a digital survey question based on emotion attributes. In some embodiments the digital survey system 104 can provide an overall response reliability score associated with a particular question. Furthermore, the digital survey system 104 can also filter (or withhold the inclusion of) digital survey responses based on the reliability of the digital survey responses. Indeed, the digital survey system 104 can filter (or withhold the inclusion of) digital survey responses that are below (or above) a threshold reliability score and/or based on a selected emotion attribute associated with the digital survey responses.

Moreover, in some instances, the digital survey system 104 can send a survey administrator a notification in the event that the reliability score associated with a particular question drops below a threshold reliability. A low reliability score may indicate that a digital survey question is poorly worded, not being taken seriously by respondents, or other problems. The notification can include a link that allows the administrator to view response data (as shown in FIG. 6) associated with the low reliability responses as well as make potential edits or cancel the use of the question in future digital surveys.

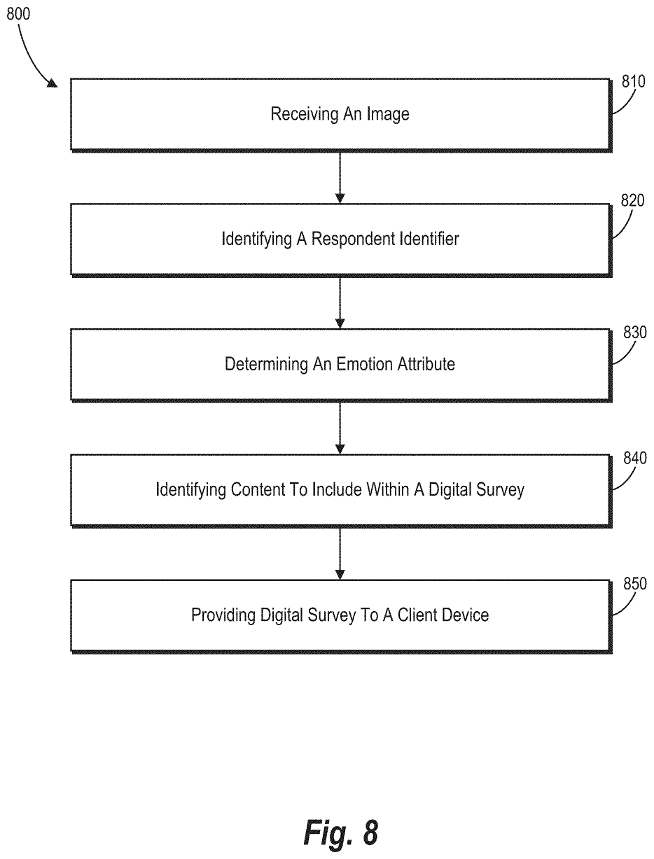

Turning now to FIG. 8, this figure illustrates a flowchart of a series of acts 800 of determining emotion attributes and identifying digital survey content based on the emotion attributes. While FIG. 8 illustrates acts according to one embodiment, alternative embodiments may omit, add to, reorder, and/or modify any of the acts shown in FIG. 8.

As shown in FIG. 8, the series of acts 800 includes an act 810 of receiving an image. In particular, act 810 includes receiving an image depicting a respondent from a capture device.

As further shown in FIG. 8, the series of acts 800 includes an act 820 of identifying a respondent identifier. In particular, act 820 can include identifying a respondent identifier based on the image captured in act 810. Furthermore, act 820 includes analyzing the image of the respondent to identify a respondent identifier corresponding to the respondent. In one or more embodiments, act 820 can include identifying one or more possible respondent identifiers based on the image by determining a confidence level for the one or more possible respondent identifiers. In some embodiments, identifying the respondent identifier based on the image further can include determining the confidence level that indicates a probability that the respondent depicted within the image corresponds to the respondent identifier. In addition, the act 820 can include determining whether the confidence level meets a threshold value.

As further shown in FIG. 8, the series of acts 800 includes an act 830 of determining an emotion attribute. In particular, act 830 includes analyzing the image of the respondent to determine an emotion attribute to associate with the respondent identifier. In one or more embodiments, act 830 also includes analyzing the image of the respondent utilizing a machine learning model to determine the emotion attribute.

As further shown in FIG. 8, the series of acts 800 includes an act 840 of identifying content to include within a digital survey. In particular, act 840 can include, based on the emotion attribute, identifying content to include within a digital survey. In some embodiments, the act 840 can include determining a survey question to include within the digital survey based on the emotion attribute associated with the respondent identifier. In one or more embodiments, the act 840 can include identifying the content to include within the digital survey based on the confidence level (from act 820). Indeed, the act 840 includes identifying a first set of questions to include in the digital survey if the confidence level meets the threshold value. In some embodiments, the act 840 includes identifying a second set of questions to include in the digital survey if the confidence level does not meet the threshold value (such that the first set of question include fewer questions than the second set of questions).

In one or more embodiments, act 840 also includes, selecting, based on the emotion attribute associated with the respondent identifier, a distribution channel to use in providing the digital survey to the client device associated with the respondent identifier. For example, the distribution channel can include one of: an e-mail; an instant message; an SMS message; a social media post; or a phone call. In some embodiments, the act 840 can also include selecting a survey question format, based on the emotion attribute associated with the respondent identifier. For instance, the survey question format can include one or more of a free form text survey, a multiple choice survey, or a slideable scale survey.

As further shown in FIG. 8, the series of acts 800 includes an act 850 of providing a digital survey to a client device. In particular, act 850 includes providing the digital survey comprising the content to a client device associated with the respondent identifier. In some embodiments, act 850 includes providing the digital survey comprising the identified content based on the emotion attributes to one or more possible client devices corresponding to one or more possible respondent identifiers. Additionally, in some embodiments, act 850 includes providing the digital survey comprising the identified content based on the emotion attributes to one or more possible client devices corresponding to one or more respondent identifiers based on the determined confidence level in act 820.

In some embodiments, the act 850 can also include receiving, from the client device associated with the respondent identifier, a digital survey response to the content of the digital survey. Additionally, the act 850 can also include determining a reliability score of the digital survey response based on the emotion attribute associated with the respondent identifier. In some embodiments, the act 850 can also include determining the reliability score of the digital survey responses by determining a sentiment of the digital survey response and comparing the sentiment of the digital survey response to the emotion attribute associated with the respondent identifier. Furthermore, the act 850 can also include receiving, from an administrator device, a request for a digital survey result report and withholding the inclusion of the digital survey response within the digital survey result report based on the reliability score of the digital survey response.

FIG. 9 illustrates a block diagram of an example computing device 900 that may be configured to perform one or more of the processes described above. One will appreciate that one or more computing devices such as the computing device 900 may implement the server device(s) 102 and/or other devices described above in connection with FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. While the example computing device 900 is shown in FIG. 9, the components illustrated in FIG. 9 are not intended to be limiting. Additional or alternative components may be used in other embodiments. Furthermore, in certain embodiments, the computing device 900 can include fewer components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions, the processor 902 may retrieve (or fetch) the instructions from an internal register, an internal cache, the memory 904, or the storage device 906 and decode and execute them. In one or more embodiments, the processor 902 may include one or more internal caches for data, instructions, or addresses. As an example, and not by way of limitation, the processor 902 may include one or more instruction caches, one or more data caches, and one or more translation lookaside buffers (“TLBs”). Instructions in the instruction caches may be copies of instructions in the memory 904 or the storage device 906.

The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The storage device 906 includes storage for storing data or instructions. As an example and not by way of limitation, storage device 906 can comprise a non-transitory computer readable medium (or a non-transitory storage medium). described above. The storage device 906 may include a hard disk drive (“HDD”), a floppy disk drive, flash memory, an optical disc, a magneto-optical disc, magnetic tape, or a Universal Serial Bus (“USB”) drive or a combination of two or more of these. The storage device 906 may include removable or non-removable (or fixed) media, where appropriate. The storage device 906 may be internal or external to the computing device 900. In one or more embodiments, the storage device 906 is non-volatile, solid-state memory. In other embodiments, the storage device 906 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 908 allows a user to provide input to, receive output from, and otherwise transfer data to and receive data from the computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example and not by way of limitation, the communication interface 910 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 910 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 910 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 may include hardware, software, or both that couples components of the computing device 900 to each other. As an example and not by way of limitation, the communication infrastructure 912 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

FIG. 10 illustrates an example network environment 1000 of the environment 100. Network environment 1000 includes a client device 1006, and a server device 1002 connected to each other by a network 1004. Although FIG. 10 illustrates a particular arrangement of client device 1006, server device 1002, and network 1004, this disclosure contemplates any suitable arrangement of client device 1006, server device 1002, and network 1004. As an example and not by way of limitation, two or more of client device 1006, and server device 1002 may be connected to each other directly, bypassing network 1004. As another example, two or more of client device 1006 and server device 1002 may be physically or logically co-located with each other in whole, or in part. Moreover, although FIG. 10 illustrates a particular number of client devices 1006, server devices 1002, and networks 1004, this disclosure contemplates any suitable number of client devices 1006, server devices 1002, and networks 1004. As an example and not by way of limitation, network environment 1000 may include multiple client devices 1006, server devices 1002, and networks 1004.

This disclosure contemplates any suitable network 1004. As an example and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, and server device 1002 to communication network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (SONET) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, client device 1006 may be an electronic device including hardware, software, or embedded logic components or a combination of two or more such components and capable of carrying out the appropriate functionalities implemented or supported by client device 1006. As an example and not by way of limitation, a client device 1006 may include any of the computing devices discussed above in relation to FIG. 10. A client device 1006 may enable a network user at client device 1006 to access network 1004.

In particular embodiments, client device 1006 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at client device 1006 may enter a Uniform Resource Locator (“URL”) or other address directing the web browser to a particular server (such as server, or a server associated with a third-party system), and the web browser may generate a Hyper Text Transfer Protocol (“HTTP”) request and communicate the HTTP request to server. The server may accept the HTTP request and communicate to client device 1006 one or more Hyper Text Markup Language (“HTML”) files responsive to the HTTP request. Client device 1006 may render a webpage based on the HTML files from the server for presentation to the user. This disclosure contemplates any suitable webpage files. As an example and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, server device 1002 may include a variety of servers, sub-systems, programs, modules, logs, and data stores. In particular embodiments, server device 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Server device 1002 may also include suitable components such as network interfaces, security mechanisms, load balancers, failover servers, management-and-network-operations consoles, other suitable components, or any suitable combination thereof.

In particular embodiments, server device 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., survey respondents 120, customers, etc.).

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving an image depicting a respondent from a capture device;
analyzing the image of the respondent to identify a respondent identifier corresponding to the respondent;
analyzing the image of the respondent to determine an emotion attribute to associate with the respondent identifier;
based on the emotion attribute, identifying content to include within a digital survey; and
providing the digital survey comprising the content to a client device associated with the respondent identifier.

2. The method of claim 1, further comprising selecting, based on the emotion attribute associated with the respondent identifier, a distribution channel to use in providing the digital survey to the client device associated with the respondent identifier.

3. The method of claim 2, wherein the distribution channel comprises one of: an e-mail; an instant message; an SMS message; a social media post; or a phone call.

4. The method of claim 1, wherein identifying the content to include within the digital survey based on the emotion attribute comprises determining a survey question to include within the digital survey based on the emotion attribute associated with the respondent identifier.

5. The method of claim 1, wherein identifying the respondent identifier based on the image further comprises determining a confidence level that indicates a probability that the respondent depicted within the image corresponds to the respondent identifier.

6. The method of claim 5, wherein identifying the content to include within the digital survey is further based on the confidence level.

7. The method of claim 5, further comprising:
determining whether the confidence level meets a threshold value; and
if the confidence level meets the threshold value, identifying a first set of questions to include in the digital survey; and
if the confidence level does not meet the threshold value, identifying a second set of questions to include in the digital survey, wherein the first set of questions comprises fewer questions than the second set of questions.

8. The method of claim 1, further comprising:
receiving, from the client device associated with the respondent identifier, a digital survey response to the content of the digital survey; and
determining a reliability score of the digital survey response based on the emotion attribute associated with the respondent identifier.

9. The method of claim 8, wherein determining the reliability score of the digital survey response comprises:
determining a sentiment of the digital survey response; and
comparing the sentiment of the digital survey response to the emotion attribute associated with the respondent identifier.

10. The method of claim 8, further comprising:
receiving, from an administrator device, a request for a digital survey result report; and
withholding the inclusion of the digital survey response within the digital survey result report based on the reliability score of the digital survey response.

11. A system comprising:
receiving an image depicting a respondent from a capture device;
analyzing the image of the respondent to identify a respondent identifier corresponding to the respondent;
analyzing the image of the respondent to determine an emotion attribute to associate with the respondent identifier;
based on the emotion attribute, identifying content to include within a digital survey; and
providing the digital survey comprising the content to a client device associated with the respondent identifier.

12. The system of claim 11, further comprising selecting, based on the emotion attribute associated with the respondent identifier, a distribution channel to use in providing the digital survey to the client device associated with the respondent identifier.

13. The system of claim 11, wherein identifying the content to include within the digital survey based on the emotion attribute comprises determining a survey question to include within the digital survey based on the emotion attribute associated with the respondent identifier.

14. The system of claim 11, wherein identifying the respondent identifier based on the image further comprises determining a confidence level that indicates a probability that the respondent depicted within the image corresponds to the respondent identifier.

15. The system of claim 14, wherein identifying the content to include within the digital survey is further based on the confidence level.

16. The system of claim 11, further comprising:
receiving, from the client device associated with the respondent identifier, a digital survey response to the content of the digital survey; and
determining a reliability score of the digital survey response based on the emotion attribute associated with the respondent identifier.

17. A non-transitory computer readable medium storing instructions thereon that, when executed by at least one processor, cause a computing device to:
receive an image depicting a respondent from a capture device;
analyze the image of the respondent to identify a respondent identifier corresponding to the respondent;
analyze the image of the respondent to determine an emotion attribute to associate with the respondent identifier;
based on the emotion attribute, identify content to include within a digital survey; and
provide the digital survey comprising the content to a client device associated with the respondent identifier.

18. The non-transitory computer readable medium of claim 17, further comprising instructions that, when executed by at least one processor, cause the computing device to select, based on the emotion attribute associated with the respondent identifier, a distribution channel to use in providing the digital survey to the client device associated with the respondent identifier.

19. The non-transitory computer readable medium of claim 17, wherein identifying the content to include within the digital survey based on the emotion attribute comprises determining a survey question to include within the digital survey based on the emotion attribute associated with the respondent identifier.

20. The non-transitory computer readable medium of claim 17, wherein identifying the respondent identifier based on the image further comprises determining a confidence level that indicates a probability that the respondent depicted within the image corresponds to the respondent identifier.
